(19) United States
(12) Patent Application Publication
(10) Pub. No.: US 2022/0276837 A1
(43) Pub. Date: Sep. 1, 2022

(54) ARITHMETIC APPARATUS AND MULTIPLY-ACCUMULATE SYSTEM

(71) Applicant: Sony Group Corporation, Tokyo (JP)

(72) Inventor: Yasushi Fujinami, Tokyo (JP)

(21) Appl. No.: 17/637,640

(22) PCT Filed: Aug. 13, 2020
(86) PCT No.: PCT/JP2020/030747

§ 371 Date: Feb. 23, 2022

(30) Foreign Application Priority Data
Sep. 2, 2019 (JP) 2019-159456

(51) Int. Cl. G06F 7/544; G06F 7/523; G06F 7/50; G06N 3/063

(52) U.S. Cl. CPC G06F 7/5443; G06F 7/523; G06F 7/50; G06N 3/0635

(57) ABSTRACT

In one example, an arithmetic apparatus includes arithmetic circuits, a signal output circuit, and a common wiring unit. The common wiring unit electrically connects signal output lines of the signal output circuit to input lines included with each of the arithmetic circuit units. The arithmetic circuits include a first arithmetic circuit and a second arithmetic circuit. The electrical signals output from the signal output lines are input into the as electrical signals corresponding to the input values via the common wiring unit. The extending directions of the output lines of the first arithmetic circuit and the output lines of the second arithmetic circuit unit are parallel to each other.

### TECHNICAL FIELD

The present technology relates to an arithmetic apparatus and a multiply-accumulate system that can be applied to a multiply-accumulate operation using an analog method.

### BACKGROUND ART

Conventionally, a technology for performing a multiply-accumulate operation has been developed. The multiply-accumulate operation is an operation of multiplying each of a plurality of input values by a weight and adding the multiplication results to each other, and is used for, for example, processing of recognizing images, voices, and the like through a neural network or the like.

For example, Patent Literature 1 describes an analog circuit in which multiply-accumulate processing is performed in an analog manner. In this analog circuit, a weight corresponding to each of a plurality of electrical signals is set. Moreover, charges depending on the corresponding electrical signals and weights are respectively output and the output charges are accumulated in a capacitor as appropriate. A value to be calculated, which represents a multiply-accumulate result, is calculated on the basis of the voltage of the capacitor in which the charges are accumulated. Accordingly, it is possible to reduce the power consumption required for the multiply-accumulate operation as compared with, for example, digital processing (paragraphs [0003], [0049] to [0053], and [0062] of specification, FIG. 3, and the like of Patent Literature 1).

### CITATION LIST

### Patent Literature

Patent Literature 1: WO 2018/034163

### DISCLOSURE OF INVENTION

### Technical Problem

The use of such an analog-type circuit is expected to lead to low power consumption of the neural network or the like, and it is desirable to provide a technology capable of improving the accuracy of the multiply-accumulate operation.

In view of the above-mentioned circumstances, it is an object of the present technology to provide an arithmetic apparatus and a multiply-accumulate system, by which the operation accuracy can be improved in an analog-type circuit that performs a multiply-accumulate operation.

### Solution to Problem

In order to accomplish the above-mentioned object, an arithmetic apparatus according to an embodiment of the present technology includes a plurality of arithmetic circuit units, a signal output circuit, and a common wiring unit.

The plurality of arithmetic circuit units each includes a plurality of input lines and a plurality of output lines.

The plurality of input lines is arranged in parallel using a predetermined direction as an extending direction and electrical signals corresponding to input values are respectively input into the plurality of input lines.

The plurality of output lines is arranged in parallel so as to intersect with the plurality of input lines, using a direction different from the predetermined direction as an extending direction, and each outputs a multiply-accumulate signal representing a sum of product values obtained by multiplying the input values, which are generated on the basis of the electrical signals input into the plurality of input lines, by weight values.

The signal output circuit includes a plurality of signal output lines capable of outputting electrical signals, respectively.

The common wiring unit electrically connects the plurality of signal output lines of the signal output circuit to the plurality of input lines, which each of the plurality of arithmetic circuit units includes.

The plurality of arithmetic circuit units includes a first arithmetic circuit unit and a second arithmetic circuit unit.

The electrical signals output from the plurality of signal output lines of the signal output circuit are input into the plurality of input lines, which each of the first arithmetic circuit unit and the second arithmetic circuit unit includes, as electrical signals corresponding to the input values via the common wiring unit.

The extending direction of the plurality of output lines of the first arithmetic circuit unit and the extending direction of the plurality of output lines of the second arithmetic circuit unit are configured to be parallel to each other.

The common wiring unit may be configured using, as a reference, a wiring reference plane set on the basis of a positional relationship between the first arithmetic circuit unit and the second arithmetic circuit unit.

The common wiring unit may include a plurality of reference wires that is arranged in parallel and extends in an identical direction on the wiring reference plane.

In each of the plurality of arithmetic circuit units, the plurality of input lines and the plurality of output lines may be arranged by using a predetermined plane as a reference plane. In this case, the wiring reference plane may be set on the basis of a positional relationship between a first reference plane that is the reference plane of the first arithmetic circuit unit and a second reference plane that is the reference plane of the second arithmetic circuit unit.

The first reference plane and the second reference plane may be disposed to be arranged side by side on an identical plane. In this case, the wiring reference plane may be set to be parallel to the identical plane on which the first reference plane and the second reference plane are disposed.

The common wiring unit may include a plurality of reference wires that is arranged in parallel and extends in an identical direction on the wiring reference plane. In this case, the extending direction of the plurality of reference wires may be set to be parallel to a direction in which the first reference plane and the second reference plane are arranged side by side.

The first reference plane and the second reference plane may be arranged side by side in the extending direction of the plurality of input lines of the first arithmetic circuit unit or the extending direction of the plurality of output lines of the first arithmetic circuit unit.

The first reference plane and the second reference plane may be arranged side by side to be orthogonal to a predetermined reference direction. In this case, the wiring reference plane may be set to be parallel to the reference direction.

The wiring reference plane may be set to be parallel to the reference direction and the extending direction of the plurality of output lines of the first arithmetic circuit unit.

The common wiring unit may include a plurality of reference wires that is arranged in parallel and extends in an identical direction on the wiring reference plane. In this case, the extending direction of the plurality of reference wires may be set to be parallel to be the reference direction.

The common wiring unit may include a plurality of reference wires that is arranged in parallel and extends in an identical direction on the wiring reference plane. In this case, the common wiring unit may include at least one of a first wiring unit that electrically connects the plurality of signal output lines of the signal output circuit to the plurality of reference wires, a second wiring unit that electrically connects the plurality of reference wires to the plurality of input lines of the first arithmetic circuit unit, or a third wiring unit that electrically connects the plurality of reference wires to the plurality of input lines of the second arithmetic circuit unit.

The common wiring unit may include the first wiring unit, the second wiring unit, and the third wiring unit. In this case, the first wiring unit, the second wiring unit, and the third wiring unit may extend in an identical direction.

The common wiring unit may include the second wiring unit and the third wiring unit. In this case, the second wiring unit and the third wiring unit may be constituted by an identical wiring unit.

The common wiring unit may include a plurality of reference wires that is arranged in parallel and extends in an identical direction on the wiring reference plane. In this case, the plurality of reference wires may be connected to each of end portions on an output side of the plurality of signal output lines of the signal output circuit, end portions on an input side of the plurality of input lines of the first arithmetic circuit unit, and end portions on an input side of the plurality of input lines of the second arithmetic circuit unit.

The extending direction of the plurality of input lines of the first arithmetic circuit unit and the extending direction of the plurality of input lines of the second arithmetic circuit unit may be configured to be parallel to each other.

The plurality of signal output lines of the signal output circuit may be arranged in parallel and extend in an identical direction. In this case, the extending direction of the plurality of signal output lines of the signal output circuit may be configured to be parallel to the extending direction of the plurality of input lines of the first arithmetic circuit unit.

The extending direction of the plurality of output lines, which each of the plurality of arithmetic circuit units includes, may be configured to be parallel to the extending direction of the plurality of output lines of the first arithmetic circuit unit. In this case, the electrical signals output from the plurality of signal output lines of the signal output circuit may be input into the plurality of input lines, which each of the plurality of arithmetic circuit units includes, as the electrical signals corresponding to the input value via the common wiring unit.

The common wiring unit may include a switch unit that outputs the electrical signals output from the plurality of signal output lines of the signal output circuit to each of the plurality of arithmetic circuit units in a switchable manner.

In order to accomplish the above-mentioned object, an arithmetic apparatus according to another embodiment of the present technology includes a plurality of arithmetic circuit units, a signal input circuit, and a common wiring unit.

The plurality of multiply-accumulate result signal output lines outputs multiply-accumulate result signals representing multiply-accumulate results generated on the basis of the multiply-accumulate signals output through the plurality of output lines.

The signal input signal includes a plurality of signal input lines into each of which the multiply-accumulate result signal output from each of the plurality of multiply-accumulate result signal output lines is input.

The common wiring unit electrically connects the plurality of multiply-accumulate result signal output lines, which each of the plurality of arithmetic circuit units includes, to the plurality of signal input lines of the signal input circuit.

The multiply-accumulate result signals output from the plurality of multiply-accumulate result signal output lines, which each of the first arithmetic circuit unit and the second arithmetic circuit unit includes, are input into the plurality of signal input lines of the signal input circuit.

The extending direction of the plurality of output lines of the first arithmetic circuit unit and the extending direction of the plurality of output lines of the second arithmetic circuit unit are configured to be parallel to each other.

A multiply-accumulate system according to an embodiment of the present technology includes the above-mentioned plurality of arithmetic circuit units the signal output circuit, the common wiring unit, and a network circuit.

The network circuit is configured by connecting the plurality of arithmetic circuit units.

### BRIEF DESCRIPTION OF DRAWINGS

FIG. 1 A schematic diagram showing a configuration example of an arithmetic apparatus according to an embodiment (one-input one-output configuration).

FIG. 2 A schematic diagram showing a configuration example of an arithmetic apparatus according to an embodiment (two-input two-output configuration).

FIG. 3 A schematic diagram showing an example of an electrical signal to be input (one-input one-output configuration).

FIG. 4 A schematic diagram showing an example of an electrical signal to be input (two-input two-output configuration).

FIG. 5 A schematic diagram showing a configuration example of an arithmetic circuit unit 5 (one-input one-output configuration).

FIG. 6 A schematic diagram showing a configuration example of a neuron circuit (one-input one-output configuration).

FIG. 7 A schematic diagram showing a configuration example of an arithmetic circuit unit 5 (two-input two-output configuration).

FIG. 8 A schematic diagram showing a configuration example of a neuron circuit (two-input two-output configuration).

FIG. A diagram showing a configuration example of an arithmetic circuit unit in the arithmetic apparatus having the one-input one-output configuration.

FIG. 10 A diagram showing a configuration example of the arithmetic circuit unit in the arithmetic apparatus having the one-input one-output configuration.

FIG. 11 A diagram showing a configuration example of an arithmetic circuit unit in the arithmetic apparatus having the two-input two-output configuration.

FIG. 12 A diagram showing a configuration example of the arithmetic circuit unit in the arithmetic apparatus having the two-input two-output configuration.

FIG. 13 A schematic diagram showing a configuration example of an inference apparatus including the arithmetic apparatus according to the present technology.

FIG. 14 A table for describing convolution operations performed by the inference apparatus.

FIG. 15 A schematic diagram for describing the convolution operations performed by the inference apparatus.

FIG. 16 A schematic diagram showing an example of a “plurality of input lines”, a “plurality of output lines”, and a “reference plane” of the arithmetic circuit unit.

FIG. 17 A schematic diagram showing an example of an arrangement configuration according to the present technology.

FIG. 18 A schematic diagram showing an example of a common wiring unit WC configured for a wiring configuration illustrated in FIG. 17.

FIG. 19 A schematic diagram showing an example of the common wiring unit WC configured for the wiring configuration illustrated in FIG. 17.

FIG. 20 A schematic diagram showing an example of a switch mechanism provided in the common wiring unit.

FIG. 21 A schematic diagram showing another configuration example of the arrangement configuration and the common wiring unit.

FIG. 22 A schematic diagram showing another example of the arrangement configuration.

FIG. 23 A schematic diagram showing an example of a common wiring unit WC configured for the wiring configuration illustrated in FIG. 22.

FIG. 24 A schematic diagram showing an example of the common wiring unit WC configured for the wiring configuration illustrated in FIG. 22.

FIG. 25 A schematic diagram showing another configuration example of the arrangement configuration and the common wiring unit.

FIG. 26 A schematic diagram showing another configuration example of the arrangement configuration and the common wiring unit.

FIG. 27 A schematic diagram showing a configuration example of the arrangement configuration and the common wiring unit configured between the plurality of arithmetic circuit units and the signal input circuit.

FIG. 28 A schematic diagram showing a configuration example of the arrangement configuration and the common wiring unit configured between the plurality of arithmetic circuit units and the signal input circuit.

FIG. 29 A schematic diagram showing a configuration example of the arrangement configuration and the common wiring unit configured between the plurality of arithmetic circuit units and the signal input circuit.

FIG. 30 A schematic diagram showing a configuration example of the arrangement configuration and the common wiring unit configured between the plurality of arithmetic circuit units and the signal input circuit.

FIG. 31 A schematic diagram showing a configuration example of the arrangement configuration and the common wiring unit configured between the plurality of arithmetic circuit units and the signal input circuit.

FIG. 32 A schematic diagram showing another configuration example of the arithmetic apparatus.

FIG. 33 A schematic diagram for describing a case where the number of inputs (number of input signal lines) of each of the plurality of arithmetic circuit units differs.

### MODE(S) FOR CARRYING OUT THE INVENTION

Hereinafter, embodiments according to the present technology will be described with reference to the drawings.

[Configuration of Arithmetic Apparatus]

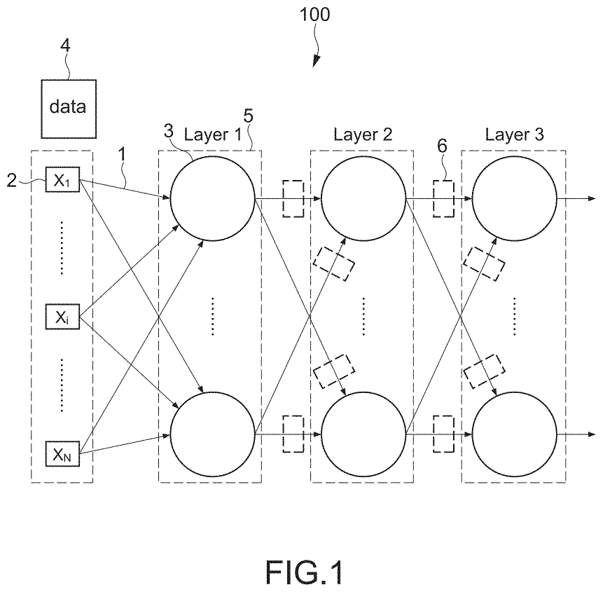

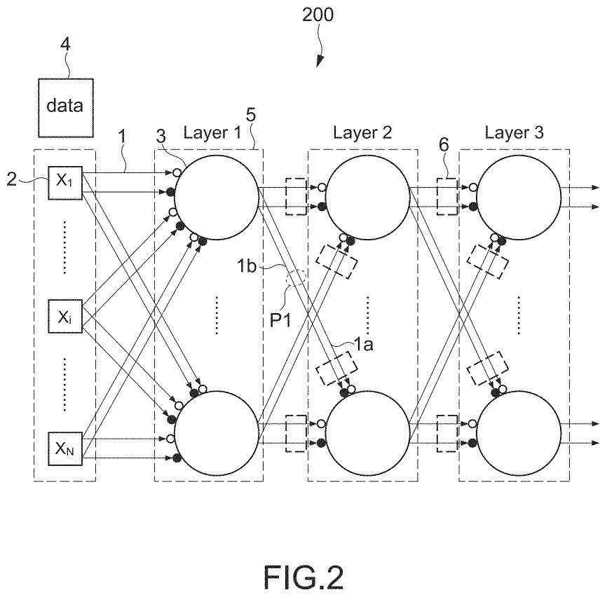

FIGS. 1 and 2 are schematic diagrams for describing a basic configuration example of an arithmetic apparatus according an embodiment of the present technology.

An arithmetic apparatus is an analog-type arithmetic apparatus that performs predetermined arithmetic processing including a multiply-accumulate operation. The use of an arithmetic apparatus 100 and an arithmetic apparatus 200 shown in FIGS. 1 and 2 makes it possible to perform arithmetic processing according to a mathematical model such as a neural network, for example.

The arithmetic apparatus 100 shown in FIG. 1 includes a plurality of signal lines 1, a plurality of input units 2, and a plurality of analog circuits 3. Each of the signal lines 1 is a line that transmits a predetermined type of electrical signal.

For example, an analog signal representing a signal value by using an analog amount such as a pulse timing and a pulse width is used as the electrical signal. The directions in which electrical signals are transmitted are schematically shown as the arrows in FIG. 1. In this embodiment, the analog circuits 3 correspond to multiply-accumulate circuits.

For example, the plurality of signal lines 1 is connected to one analog circuit 3. The signal line 1 that transmits an electrical signal to the analog circuit 3 is an input signal line into which an electrical signal is input for the analog circuit 3 to which that signal line 1 is connected.

Moreover, the signal line 1 that transmits an electrical signal output from the analog circuit 3 is an output signal line from which an electrical signal is output for the analog circuit 3 to which that signal line 1 is connected.

The plurality of input units 2 respectively generates a plurality of electrical signals corresponding to input data 4. The input data 4 is, for example, data to be processed using a neural network or the like implemented by the arithmetic apparatus 100. Therefore, it can also be said that each signal value of the plurality of electrical signals corresponding to the input data 4 is an input value to the arithmetic apparatus 100.

For example, arbitrary data such as image data, audio data, and statistical data to be processed by the arithmetic apparatus 100 is used as the input data 4. For example, in a case where image data is used as the input data 4, an electrical signal using a pixel value (RGB value, luminance value, etc.) of each of pixels of the image data as a signal value is generated. In addition, an electrical signal corresponding to the input data 4 may be generated as appropriate in accordance with the type of the input data 4 and the contents of the processing performed by the arithmetic apparatus 100.

The analog circuit 3 is an analog-type circuit that performs a multiply-accumulate operation on the basis of an input electrical signal. The multiply-accumulate operation is, for example, an operation of adding up a plurality of product values obtained by multiplying a plurality of input values by weight values corresponding to input values. Therefore, it can also be said that the multiply-accumulate operation is processing of calculating a sum of the product values (hereinafter, referred to as a multiply-accumulate result).

As shown in FIG. 1, a plurality of input signal lines is connected to a single analog circuit 3 and a plurality of electrical signals is provided to the single analog circuit 3. The plurality of input signal lines and the plurality of analog circuits 3 constitute an arithmetic circuit unit 5 according to this embodiment. Moreover, a plurality of electrical signals is input from each of the input signal lines, and a multiply-accumulate method according to this embodiment is accordingly performed by the multiply-accumulate circuit (analog circuit 3).

Hereinafter, it is assumed that the total number of electrical signals input into one analog circuit 3 is denoted by N. It should be noted that the number N of electrical signals to be input into each analog circuit 3 is set as appropriate for each circuit in accordance with, for example, the model, accuracy, and the like of arithmetic processing.

In the analog circuit 3, for example, wᵢ*xᵢ is calculated which is a product value of an input value xᵢ represented by an electrical signal input from an i-th input signal line and a weight value wᵢ corresponding to the input value xᵢ. Here, i represents a natural number equal to or smaller than N (i=1, 2, . . . , N). The operation of the product value is performed for each electrical signal (input signal line) and N product values are calculated. A value obtained by adding up the N product values is calculated as a multiply-accumulate result (sum of N product values). Therefore, the multiply-accumulate result calculated by one analog circuit 3 is expressed by the following expression.

$${\sum }_{i = 1}^{N} {w}_{i} \cdot {x}_{i} \qquad [ Formula 1 ]$$

The weight value wᵢ is set, for example, in the range of −α≤wᵢ≤+α. Here, α represents an arbitrary real value. Thus, the weight value wᵢ may include a positive weight value wᵢ, a negative weight value wᵢ, a zero weight value wᵢ, and the like. As described above, by setting the weight value wᵢ to be in a predetermined range, it is possible to avoid the situation where the multiply-accumulate result diverges.

Moreover, for example, the range in which the weight value wᵢ is set may be normalized. In this case, the weight value wᵢ is set to be in a range of −1≤wᵢ≤1. Accordingly, for example, the maximum value, the minimum value, and the like of the multiply-accumulate result can be adjusted, and the multiply-accumulate operation can be performed with a desired accuracy.

In a neural network or the like, a method called binary connect, which sets the weight value wᵢ to be either +α or −α, can be used. The binary connect is used in various fields such as image recognition using a deep neural network (multi-layer neural network).

The use of the binary connect can simplify the setting of the weight value wᵢ without deteriorating the recognition accuracy and the like. In the binary connect, the positive weight value and the absolute value of the negative weight value are fixed to the same value.

As described above, in the binary connect, the weight value wᵢ is binarized into a binary value (±α). Thus, a desired weight value wᵢ can be easily set by changing the weight value wᵢ to be positive or negative, for example. Alternatively, the binarized weight value wᵢ may be normalized and the weight value wᵢ may be set to ±1.

Alternatively, the weight value wᵢ may be multi-valued. In this case, the weight values wᵢ are selected and set from among a plurality of discrete weight value candidates. Examples of the weight value candidates can include an example of (−3, −2, −1, 0, 1, 2, 3) and an example of (1, 2, 5, 10).

Alternatively, normalized weight value candidates (−1, −0.5, 0, 0.5, 1) or the like may be used. Values are selected from among those weight value candidates and are set as the weight values wᵢ. The number of weight value candidates, the method of setting candidate values, and the like are not limited. By making the weight value wᵢ multi-valued, a more versatile neural network or the like can be built, for example.

In addition, the setting range, the setting value, and the like of the weight value wᵢ are not limited, and may be set as appropriate such that desired processing accuracy is realized, for example. For example, the weight value wᵢ may be randomly set.

The input values xᵢ shown in the expression (Formula 1) are, for example, the values of the input data 4 output from the input units 2 and the values of multiply-accumulate results output from the analog circuits 3. Thus, it can also be said that the input units 2 and the analog circuits 3 function as signal sources for outputting the input values xᵢ.

In the example shown in FIG. 1, a single electrical signal (single input value xᵢ) is output from one signal source (input unit 2, analog circuit 3). Therefore, the same electrical signal is input into each of the plurality of signal lines 1 connected to an output side of the one signal source. Moreover, one signal source and the analog circuit 3 into which the electrical signal output from the signal source is input are connected to each other through a single input signal line.

Therefore, for example, an M-number of input signal lines are connected to the analog circuit 3 connected to an M-number of signal sources in the arithmetic apparatus 100 shown in FIG. 1. In this case, the total number N of electrical signals input into the analog circuits 3 is N=M.

As shown in FIG. 1, the arithmetic apparatus 100 has a layered structure in which the plurality of analog circuits 3 is provided in each of a plurality of layers. That is, a plurality of arithmetic circuit units 5 is cascade-connected.

A multi-layer perceptron (MLP)-type neural network or the like, for example, is built by configuring the layered structure of the analog circuits 3. The number of analog circuits provided in each layer, the number of layers, and the like are designed as appropriate such that desired processing can be performed, for example. Hereinafter, the number of analog circuits 3 provided in a j-th layer will be sometimes referred to as Nⱼ.

For example, an N-number of electrical signals generated by an N-number of input units 2 are input into each analog circuit 3 provided in a layer of a first stage (lowest layer). The analog circuits 3 of the first stage calculate multiply-accumulate results related to the input values xᵢ of the input data, and output the calculated multiply-accumulate results to the analog circuits 3 provided in a next layer (second stage) after the non-linear transformation processing.

An N₁-number of electrical signals representing the respective multiply-accumulate results calculated in the first stage are input into the respective analog circuits 3 provided in a second layer (upper layer). Therefore, as viewed from the analog circuits 3 of the second stage, the non-linear transformation processing results of the respective multiply-accumulate results calculated in the first stage are the input values xᵢ of the electrical signals. The analog circuits 3 of the second stage calculate the multiply-accumulate results of the input values xᵢ output from the first stage, and output the calculated multiply-accumulate results to the analog circuits 3 of the upper layer.

In this way, in the arithmetic apparatus 100, the multiply-accumulate results of the analog circuits 3 in the upper layer are calculated on the basis of the multiply-accumulate results calculated by the analog circuits 3 in the lower layer. Such processing is performed multiple times, and the processing results are output from the analog circuits 3 included in the top layer (layer of the third stage in FIG. 1). Accordingly, for example, processing such as image recognition of determining that the object is a cat on the basis of image data (input data 4) obtained by imaging the cat can be performed.

As described above, a desired network circuit can be configured by connecting the arithmetic circuit units 5 including the plurality of analog circuits 3 as appropriate. The network circuit functions as a data flow processing system that performs arithmetic processing by, for example, causing signals to pass therethrough. In the network circuit, various processing functions can be realized by setting, for example, a weight value (synapse connection) as appropriate. With this network circuit, the multiply-accumulate system according to this embodiment is built.

It should be noted that the method of connecting the analog circuits 3 to each other and the like are not limited, and, for example, the plurality of analog circuits 3 may be connected to each other as appropriate such that desired processing can be performed. For example, the present technology can be applied even in a case where the analog circuits 3 are connected to each other so as to configure another structure different from the layered structure.

For example, a configuration in which electrical signals corresponding to the input data 4 or electronic signals corresponding to multiply-accumulate results output from the analog circuits 3 in the previous layer are output in a switchable manner from the one signal source to the plurality of analog circuits 3 which each of the plurality of arithmetic circuit units 5 includes is also possible.

For example, it is assumed that the input data 4 has been stored in a storage device as digital data. Moreover, it is assumed that the multiply-accumulate results output from the plurality of analog circuits 3 of the arithmetic circuit unit 5 in each layer have also been converted into digital data and stored.

In such a case, for example, through the signal source, the input data 4 read from the storage device is converted into analog signals (electrical signals) and input into the respective analog circuits 3 in the lowest layer. Moreover, for example, through the same signal source, the digital data of the multiply-accumulate results of the analog circuits 3 in the L-th layer is read and converted into analog signals (electrical signals), and then input into the analog circuits 3 in the L+1-th layer.

In this manner, the embodiment of the arithmetic apparatus 100 according to the present technology can also be realized with the configuration in which the common signal source is used for the plurality of arithmetic circuit units 5.

Moreover, the present technology is not limited to the configuration in which the multiply-accumulate results calculated in the lower layer are input into the upper layer as they are, for example, transformation processing or the like may be performed on the multiply-accumulate results. For example, in the neural network model, processing of, for example, performing non-linear transformation on the multiply-accumulate result of each analog circuit 3 by using an activation function and inputting the transformation results to the upper layer is performed.

In the arithmetic apparatus 100, a function circuit 6 or the like that performs non-linear transformation using an activation function on the electrical signal, for example, is used. The function circuit 6 is, for example, a circuit that is provided between a lower layer and an upper layer and that converts a signal value of an input electrical signal as appropriate and outputs an electrical signal corresponding to the transformation result. The function circuit 6 is provided for each of the signal lines 1, for example. The number of function circuits 6, the arrangement of the function circuits 6, and the like are set as appropriate in accordance with, for example, the mathematical model implemented in the arithmetic apparatus 100.

For example, a ReLU function (ramp function) or the like is used as the activation function. The ReLU function outputs the input value xᵢ as it is in a case where the input value xᵢ is 0 or more, for example, and outputs 0 otherwise. For example, the function circuit 6 that implements the ReLU function is connected to each of the signal lines 1 as appropriate. Accordingly, it is possible to realize the processing of the arithmetic apparatus 100.

An enlargement circuit that enlarges the analog signal output as the multiply-accumulate result may be further provided.

In the arithmetic apparatus 200 shown in FIG. 2, the signal line 1 includes a positive signal line 1a and a negative signal line 1b. The positive and negative signal lines 1a and 1b are arranged as a pair. The positive and negative signal lines 1a and 1b are used as a pair of signal lines 1. Hereinafter, the pair of signal lines 1 constituted by the positive and negative signal lines 1a and 1b will be referred to as a signal line pair P1. It should be noted that in FIG. 2, the positive signal line 1a is a signal line 1 connected to the white circle connection point and the negative signal line 1b is a signal line 1 connected to the black circle connection point.

The signal line pair P1 transmits a signal pair corresponding to a single input value (or output value). The signal pair is a pair of electrical signals input into the positive and negative signal lines 1a and 1b, respectively. The respective signal values of this pair of electrical signals represent the input value. That is, it can also be said that the signal line pair P1 functions as a single transmission path that transmits the input value.

An input value x is expressed using a sum of a positive value x⁺ and a negative value x⁻. Here, the positive value x⁺ is a real number equal to or larger than 0 (x⁺≥0). Moreover, the negative value x⁻ is a real number equal to or smaller than 0 (x⁻≤0). Thus, the input value x is expressed as x=x⁺+x⁻ that is the sum of the positive value x⁺ and the negative value x⁻. Here, with an absolute value of the negative value x⁻, the input value x is expressed as x=x⁺−|x⁻| that is a difference between the positive value x⁺ and the absolute value of the negative value x⁻. In this manner, the input value x can be expressed using a difference between the two positive real numbers.

In this embodiment, the signal pair includes a positive signal and a negative signal. The positive signal is an electrical signal having the positive value x⁺ as the signal value. The positive signal is input into the positive signal line 1a. The negative signal is an electrical signal having the absolute value |x⁻| of the negative value x⁻ as the signal value. The negative signal is input into the negative signal line 1b. Thus, the positive and negative signals included in the signal pair are electrical signals both representing the positive real numbers.

Thus, in this embodiment, the input value x expressed using the signal pair is the difference between the signal value (positive value x⁺) of the positive signal input into the positive signal line 1a and the signal value (negative value x⁻) of the negative signal input into the negative signal line 1b. In other words, the positive and negative signals (signal pair) are generated such that a value obtained by subtracting the signal value of the negative signal from the signal value of the positive signal is the input value x.

The plurality of input units 2 each generates a signal pair corresponding to the value (input value x) of the input data 4. For example, arbitrary data such as image data, audio data, and statistical data to be processed by the arithmetic apparatus 200 is used as the input data 4. In addition, a signal pair corresponding to the input data 4 may be generated as appropriate in accordance with the type of the input data 4 and the contents of the processing performed by the arithmetic apparatus 200.

The analog circuit 3 is an analog-type circuit that performs a multiply-accumulate operation on the basis of a plurality of input signal pairs.

Assuming that the total number of signal pairs (input signal line pairs) input into the single analog circuit 3 is denoted by N in the arithmetic apparatus 200, the total number of input signal lines connected to the analog circuit 3 is 2×N.

Moreover, in a multiply-accumulate operation using a signal pair, a signal value (positive value xᵢ⁺) of a positive signal input into the positive signal line 1a and a signal value (negative value xᵢ⁻) of a negative signal input into the negative signal line 1a are each multiplied by the corresponding weight value to calculate two product values. The product value wᵢ*xᵢ of the input value xᵢ and the weight value wᵢ is expressed using those two product values.

As shown in FIG. 2, in the arithmetic apparatus 200, the pair of electrical signals (signal pair) corresponding to the input value xᵢ is output from one signal source (input unit 2, analog circuit 3) via the signal line pair P1. That is, the same signal pair is input into each signal line pair P1 connected to an output side of the one signal source. Moreover, the one signal source and the analog circuit 3 into which an electrical signal output from that signal source is input are connected to each other through a single line pair P1 (input signal line pair).

Therefore, for example, an M-number of input signal line pairs are connected to the analog circuit 3 connected to an M-number of signal sources in the arithmetic apparatus 200 shown in FIG. 2. In this case, the total number N of signal pairs input into the analog circuits 3 is N=M. It should be noted that the total number of electrical signals input into the analog circuit 3, i.e., the total number of signal lines 1 connected to an input side is 2×M.

It should be noted that the embodiment of the arithmetic apparatus 200 according to the present technology can also be realized with the configuration in which the common signal source is used for the plurality of arithmetic circuit units 5.

In the arithmetic apparatus 100 shown in FIG. 1, a single signal corresponding to a single input value xᵢ is input and a single signal is output as the multiply-accumulate result output from the analog circuit 3. In the arithmetic apparatus 200 shown in FIG. 2, a pair of two signals (signal pair) corresponding to a single input value xᵢ is input and a pair of two signals (signal pair) is output as the multiply-accumulate result output from the analog circuit 3.

Hereinafter, the arithmetic apparatus 100 will be referred to as an arithmetic apparatus having a one-input one-output configuration in some cases. Moreover, the arithmetic apparatus 200 will be referred to as an arithmetic apparatus having a two-input two-output configuration in some cases.

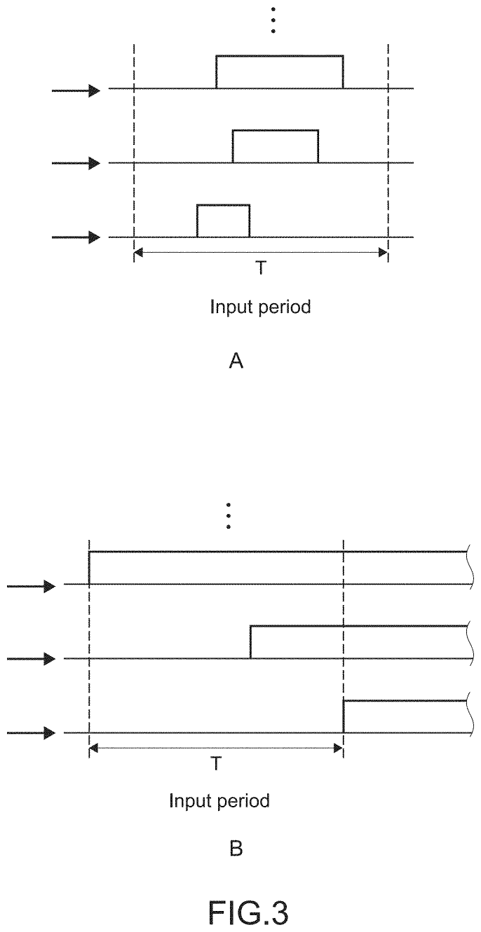

FIG. 3 is a schematic diagram showing an example of the electrical signal input into the analog circuit 3 of the arithmetic apparatus 100 having the one-input one-output configuration.

In each of FIGS. 3A and B, a graph representing a waveform of a plurality of electrical signals is schematically shown. The horizontal axis of the graph indicates the time axis and the vertical axis indicates the voltage of the electrical signal.

An exemplary waveform of an electrical signal according to a pulse width modulation (PWM) method is shown in FIG. 3A. The PWM method is a method of representing an input value xᵢ by using a pulse width of a pulse waveform, for example.

That is, in the PWM method, the pulse width of the electrical signal is a length depending on the input value xᵢ. Typically, the longer the pulse width, the higher the input value xᵢ.

Moreover, the electrical signal is input into the analog circuit 3 within a predetermined input period T. More specifically, the respective electrical signals are input into the analog circuits 3 such that the pulse waveforms of the electrical signals fall in the input period T.

Therefore, the maximum value of the pulse width of the electrical signal is similar to the input period T. It should be noted that the timing at which each pulse waveform (electrical signal) is input and the like are not limited as long as the pulse waveform falls in the input period T.

In the PWM method, for example, a duty ratio Rᵢ (=τᵢ/T) of the pulse width τᵢ to the input period T can be used to normalize the input value xᵢ. That is, the normalized input value xᵢ is represented as the input value xᵢ=the duty ratio Rᵢ.

It should be noted that the method of associating the input value xᵢ with the pulse width τᵢ is not limited and, for example, the pulse width τᵢ representing the input value xᵢ may be set as appropriate such that the calculation processing or the like can be performed with a desired accuracy.

In a case where the electrical signal according to the PWM method is used, a time-axis analog multiply-accumulate operation using the analog circuit 3 according to the PWM method can be performed.

In FIG. 3B, an exemplary waveform of the electrical signal of a spike timing method (hereinafter, referred to as TACT method) is shown.

The TACT method is a method of representing an input value xᵢ by using the rising timing of the pulse, for example. For example, a pulse is input at a timing corresponding to the input value by using a predetermined timing as a reference.

The electrical signal is input into the analog circuit 3 within the predetermined input period T. The input value xᵢ is represented by the input timing of the pulse within this input period T. For example, a largest input value xᵢ is represented by a pulse input at the same time as the start of the input period T. A smallest input value xᵢ is represented by a pulse input at the same time as the end of the input period T.

It can also be said that the input value xᵢ is represented by the duration from the input timing of the pulse to the end timing of the input period T.

For example, the largest input value xᵢ is represented by a pulse whose duration from the input timing of the pulse to the end timing of the input period T is equal to the input period T. The smallest input value xᵢ is represented by a pulse whose duration from the input timing of the pulse to the end timing of the input period T is 0.

It should be noted that in FIG. 3B, a continuous pulse signal that rises to a timing corresponding to the input value and keeps the ON level until the multiply-accumulate result is obtained is used as the electrical signal according to the TACT method. The present technology is not limited thereto, and a rectangular pulse or the like having a predetermined pulse width may be used as the electrical signal according to the TACT method.

In a case where the electrical signal according to the TACT method is used, a time-axis analog multiply-accumulate operation using the analog circuit 3 according to the TACT method can be performed.

As illustrated in FIGS. 3A and B, a pulse signal whose duration of the ON time with respect to the input period T corresponds to the input value can be used as an electrical signal corresponding to the input value. It should be noted that hereinafter, the description will be made assuming that the input value xᵢ represented by each electrical signal is a variable of 0 or more and 1 or less.

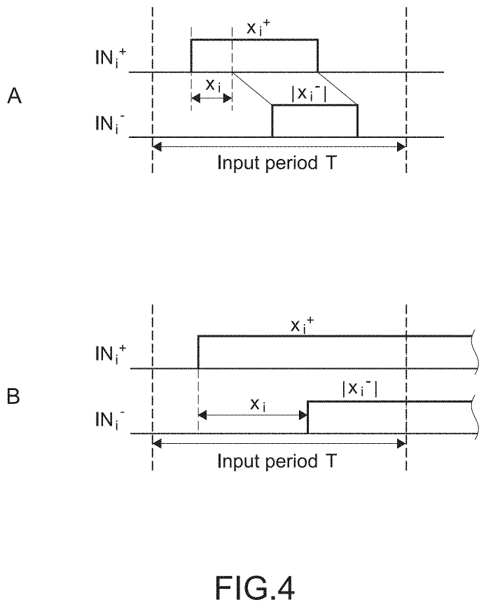

FIG. 4 is a schematic diagram showing an example of the signal pair input into the analog circuit 3 of the arithmetic apparatus 200 having the two-input two-output configuration. FIGS. 4A and B each schematically show a graph representing waveforms of the pair of electrical signals (signal pair).

In each of FIGS. 4A and B, the upper graph represents a waveform of an electrical signal (positive signal IN⁺) input into the positive signal line 1a. Moreover, the lower graph represents a waveform of an electrical signal (negative signal IN⁻) input into the negative signal line 1b. The horizontal axis of the graph indicates the time axis and the vertical axis indicates the voltage of the electrical signal.

FIG. 4A shows an example of a waveform of the electrical signal according to the PWM method. In the PWM method, a positive signal INᵢ⁺ is an electrical signal having a pulse width corresponding to a positive value xᵢ⁺ that is its signal value. Moreover, a negative signal INᵢ⁻ is an electrical signal having a pulse width corresponding to an absolute value |xᵢ⁻| of a negative value xᵢ⁻ that is its signal value. It should be noted that the positive signal INᵢ⁺ and the negative signal INᵢ⁻ may be input at different timings.

Moreover, the input value xᵢ of the signal pair is a value obtained by subtracting the pulse width of the negative signal INᵢ⁻ from the pulse width of the positive signal INᵢ⁺. Thus, in the signal pair according to the PWM method, a difference between the pulse widths of the respective electrical signals (positive signal INᵢ⁺ and negative signal INᵢ⁻) input into the positive and negative signal lines 1a and 1b represents the input value xᵢ.

FIG. 4B shows an example of a waveform of the electrical signal according to the TACT method. In the TACT method, the positive signal INᵢ⁺ is an electrical signal whose pulse is input at a timing corresponding to a positive value xᵢ⁺ that is its signal value. Moreover, the negative signal INᵢ⁻ is an electrical signal whose pulse is input at a timing corresponding to an absolute value |xᵢ⁻| of a negative value xᵢ⁻ that is its signal value.

The input value xᵢ of the signal pair is represented by the difference between the positive value xᵢ⁺ and the absolute value of the negative value xᵢ⁻. Thus, the input value xᵢ is a value obtained by subtracting the input timing of the pulse of the negative signal INᵢ⁻ from the input timing of the pulse of the positive signal INᵢ⁺. In this manner, in the signal pair according to the TACT method, the difference between the input timings of the pulses input into the positive and negative signal lines 1a and 1b represents the input value xᵢ.

It should be noted that in FIG. 4B, continuous pulse signals each of which rises to a timing corresponding to the signal value and keeps the ON level until the multiply-accumulate result is obtained, are used as the electrical signals (positive and negative signals) according to the TACT method. The present technology is not limited thereto, and a rectangular pulse or the like having a predetermined pulse width may be used as the electrical signal according to the TACT method.

FIG. 5 is a schematic diagram showing a configuration example of the arithmetic circuit unit 5 provided as one layer in the arithmetic apparatus 100 having the one-input one-output configuration.

The arithmetic circuit unit 5 includes a plurality of input signal lines 7 and a plurality of analog circuits 3.

A signal corresponding to the input value xᵢ is input into each of the plurality of input signal lines 7 within the predetermined input period T. For example, the electrical signal according to the PWM method or the TACT method described with reference to FIG. 3 is input into each input signal line 7 during the input period T.

Each analog circuit 3 includes a pair of output lines 8, a plurality of synapse circuits 9, and a neuron circuit 10.

As shown in FIG. 5, one analog circuit 3 is configured to extend in a predetermined direction (vertical direction in the figure). A plurality of such analog circuits 3 extending in the vertical direction are arranged in parallel in the horizontal direction, such that the arithmetic circuit unit 5 is configured as one layer. Hereinafter, it is assumed that the analog circuit 3 disposed on the leftmost side in the figure is a first analog circuit 3.

The pair of output lines 8 is spaced apart from each other. The pair of output lines 8 includes a positive charge output line 8a and a negative charge output line 8b.

Each of the positive charge output line 8a and the negative charge output line 8b is connected to the neuron circuit 10 via the plurality of synapse circuits 9.

The plurality of synapse circuits 9 is arranged respectively corresponding to the plurality of input signal lines 7. A single input signal line 7 is connected to a single synapse circuit 9. The number of synapse circuits 9 provided in the single analog circuit 3 is set to be equal to or smaller than the number of input signal lines 7, for example. That is, the synapse circuit 9 does not need to be connected to all the input signal lines 7.

In this manner, the plurality of synapse circuits 9 is respectively connected to at least some of the plurality of input signal lines 7. The input signal lines 7 to which the synapse circuits 9 are connected (i.e., the arrangement of the synapse circuits 9) is selected as appropriate by, for example, using a mathematical model, a simulation, or the like implemented in the arithmetic apparatus 100.

The synapse circuit 9 calculates a product value (wᵢ*xᵢ) of the input value xᵢ represented by the electrical signal and the weight value wᵢ. Specifically, a charge (current) corresponding to the product value is output to either the positive charge output line 8a or the negative charge output line 8b as a multiply-accumulate signal.

Either the positive weight value wᵢ⁺ or the negative weight value is set to the synapse circuit 9. For example, a positive weight charge corresponding to the product value of the positive weight value wᵢ⁺ is output to the positive charge output line 8a. Moreover, for example, a negative weight charge corresponding to the product value of the negative weight value wᵢ⁻ is output to the negative charge output line 8b.

It should be noted that in the synapse circuit 9, a charge with the same sign (e.g., a positive charge) is output as the charge corresponding to the product value irrespective of whether the weight value wᵢ is positive or negative. That is, the positive weight charge and the negative weight charge become charges with the same sign.

In this way, the synapse circuits 9 are each configured to output the charge corresponding to the multiplication result to the different output line 7a or 7b in accordance with the sign of the weight value wᵢ.

In this embodiment, the plurality of synapse circuits 9 functions as a plurality of multiplication units that each generates, on the basis of an electrical signal input into each of the plurality of input lines, a charge corresponding to a product value obtained by multiplying an input value by a weight value and outputs the charge to the output line as the multiply-accumulate signal.

In this embodiment, the single input signal line 7 and the pair of output lines 8 are connected to the single synapse circuit 9. That is, a single electrical signal is input into the single synapse circuit 9 and a charge corresponding to the product value calculated on the basis of the input electrical signal is output to either the charge output line 8a or 8b. Thus, the synapse circuit 9 is a one-input two-output circuit connected to the single input signal line 7 and the pair of output lines 8 (positive charge output line 8a and the negative charge output line 8b).

In one analog circuit 3, the plurality of synapse circuits 9 is arranged along the pair of output lines 8. Each synapse circuits 9 is connected in parallel to the positive charge output line 8a (negative charge output line 8b). Hereinafter, it is assumed that the synapse circuit 9 disposed on a most downstream side (side connected to the neuron circuit 10) is a first synapse circuit.

As shown in FIG. 5, the plurality of input signal lines 7 is arranged so as to intersect with the pair of output lines 8 of each of the plurality of analog circuits 3. Typically, the input signal line 7 is provided to be orthogonal to each output line 8. That is, the arithmetic apparatus 100 has a crossbar configuration in which the input signal lines 7 and the output lines 8 cross each other. With the crossbar configuration, the analog circuits 3 and the like, for example, can be integrated at high density.

Moreover, in the arithmetic apparatus 100, j-th synapse circuits 9 included in the respective analog circuits 3 are connected in parallel to a j-th input signal line 7. Therefore, similar electrical signals are input into the synapse circuits 9 connected to the same input signal line 7. Accordingly, a configuration in which one signal source included in the lower layer is connected to a plurality of analog circuits 3 included in the upper layer can be implemented.

It should be noted that in the example shown in FIG. 5, the analog circuit 3 (pre-neuron) included in the lower layer is schematically shown as a signal source that inputs an electrical signal into each of the input signal lines 7. The present technology is not limited thereto, and, for example, the crossbar configuration can be used also in a case where the input unit 2 is used as the signal source.

As described above, in the arithmetic apparatus 100, the plurality of analog circuits 3 is connected in parallel to each of the plurality of input signal lines 7. Accordingly, for example, it is possible to input electrical signals in parallel into the respective analog circuits 3 (each synapse circuit 9) and to achieve arithmetic processing at high speed. As a result, it is possible to exhibit excellent operation performance.

The neuron circuit 10 calculates a multiply-accumulate result shown in the expression (Formula 1) on the basis of the product values calculated by the synapse circuits 9. Specifically, the neuron circuit 10 outputs an electrical signal representing the multiply-accumulate result as a multiply-accumulate result signal on the basis of charges input via the pair of output lines 8.

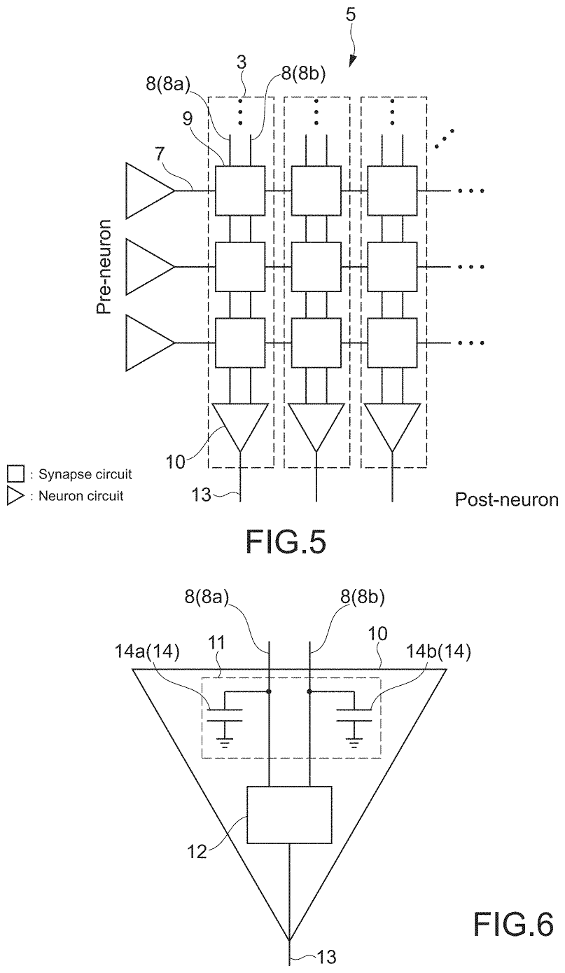

FIG. 6 is a schematic diagram showing a configuration example of the neuron circuit 10. The neuron circuit 10 includes an accumulation unit 11 and a signal output unit 12. FIG. 6 shows a two-input one-output neuron circuit 10 connected to a pair of output lines 8 and a single output signal line 13.

The accumulation unit 11 accumulates charges output to the pair of output lines 8 by the plurality of synapse circuits 9. The accumulation unit 11 includes two capacitors 14a and 14b. The capacitor 14a is connected between the positive charge output line 8a and the GND. Moreover, the capacitor 14b is connected between the negative charge output line 8b and the GND.

Therefore, charges flowing in from the positive charge output line 8a and the negative charge output line 8b are respectively accumulated in the capacitors 14a and 14b. It should be noted that the capacitors 14a and 14b are set to have the same capacitance.

For example, at a timing at which the input period T of electrical signals ends, the charges accumulated in the capacitor 14a are a sum total σ⁺ of positive weight charges each corresponding to the product value of the positive weight value wᵢ⁺.

Also, the charges accumulated in the capacitor 14b are a sum total σ⁻ of negative weight charges corresponding to the product value of the negative weight value wᵢ⁻.

For example, in a case where the positive weight charges are accumulated in the capacitor 14a, the potential of the positive charge output line 8a with reference to the GND increases. Therefore, the potential of the positive charge output line 8a is a value depending on the sum total σ⁺ of the charges each corresponding to the product value of the positive weight value wᵢ⁺. It should be noted that the potential of the positive charge output line 8a corresponds to the voltage retained by the capacitor 14a.

Similarly, in a case where the negative weight charges are accumulated in the capacitor 14b, the potential of the negative charge output line 8b with reference to the GND increases. Therefore, the potential of the negative charge output line 8b is a value depending on the sum total σ⁻ of the charges each corresponding to the product value of the negative weight value wᵢ⁻. It should be noted that the potential of the negative charge output line 8b corresponds to the voltage retained by the capacitor 14b.

The signal output unit 12 outputs a multiply-accumulate result signal representing a sum of the product values (wᵢ⁺*xᵢ) on the basis of the charges accumulated in the accumulation unit 11. The multiply-accumulate result signal is, for example, a signal representing a total multiply-accumulate result, which is a sum of product values of all positive and negative weight values wᵢ and input values xᵢ. For example, the multiply-accumulate result represented by the expression (Formula 1) can be written as follows.

$${\sum }_{i = 1}^{N} {w}_{i} {x}_{i} = {\sum }_{i = 1}^{{N}^{+}} {w}_{i}^{+} {x}_{i} - {\sum }_{i = 1}^{{N}^{-}} \vert {w}_{i}^{-} \vert {x}_{i} \qquad [ Formula 2 ]$$

Here, N⁺ and N⁻ are the total number of positive weight values wᵢ⁺ and the total number of negative weight values wᵢ⁻, respectively. As shown in the expression (Formula 2), the total multiply-accumulate result can be calculated as a difference between a multiply-accumulate result of positive weight charges, which is a sum total of product values (wᵢ⁺*xᵢ) of the positive weight values wᵢ⁺, and a multiply-accumulate result of negative weight charges, which is a sum total of product values (|wᵢ⁻|*xᵢ) of the negative weight values wᵢ⁻.

In the example shown in FIG. 6, the signal output unit 12 generates one signal representing the total multiply-accumulate result, for example, as the multiply-accumulate result signal. Specifically, by referring to the charges accumulated in the accumulation unit 11 (capacitors 14a and 14b) as appropriate, a positive multiply-accumulate result and a negative multiply-accumulate result are calculated, and the total multiply-accumulate result is calculated on the basis of the difference therebetween.

The method of referring to the charges accumulated in the accumulation unit 11 is not limited. As an example, a method of detecting charges accumulated in one capacitor 14 will be described.

In a case where the electrical signal according to the PWM method illustrated in FIG. 3A is used, the charges each corresponding to the product value are accumulated in the capacitor 14 within the input period T. That is, the accumulation of charges each corresponding to the product value does not occur before and after the input period T.

For example, after the input period T ends, the capacitor 14 is charged at a predetermined charging speed. At this time, a comparator or the like is used to detect a timing at which the potential of the output line to which the capacitor 14 is connected reaches a predetermined threshold potential.

For example, as more charges are accumulated at the time of starting charging, the timing at which the potential reaches the threshold potential becomes earlier. Therefore, the charges (multiply-accumulate result) accumulated within the input period T can be represented on the basis of the timing. It should be noted that the charging speed can be expressed by, for example, a charge amount per unit time, and can also be referred to as a charging rate.

It should be noted that this threshold determination corresponds to increasing the voltage retained by the capacitor 14 by charging and detecting a timing at which the threshold voltage is reached.

In a case where the electrical signal according to the TACT method illustrated in FIG. 3B is used, charges are accumulated in the capacitor 14 because the ON level is maintained also after the input period T ends. For this charge accumulation, a timing at which the potential of the output line to which the capacitor 14 is connected reaches the predetermined threshold potential is detected by using the comparator or the like.

For example, as more charges are accumulated at the end of input period T, the timing at which the potential reaches the threshold potential becomes earlier. Therefore, the charges (multiply-accumulate result) accumulated within the input period T can be represented on the basis of the timing.

It should be noted that this threshold determination corresponds to detecting a timing at which the voltage retained by the capacitor 14 reaches the threshold voltage.

For example, a timing to represent the multiply-accumulate result is detected by performing such threshold determination. The multiply-accumulate result signal related to positive weight charges, the multiply-accumulate result signal related to negative weight charges, or the total multiply-accumulate result signal is generated as appropriate on the basis of the detection result.

In addition, each multiply-accumulate result may be calculated by directly reading the potential of the capacitor 14 when the input period T ends, for example.

In this embodiment, the multiply-accumulate result signal is a signal including information regarding the timing, which corresponds to the sum of the product values obtained by multiplying the input values by the weight values.

It should be noted that the voltage depending on the accumulated positive weight charges and the voltage depending on the accumulated negative weight charges may be each amplified in order to generate the multiply-accumulate result signal. Moreover, the multiply-accumulate result signal may be generated by amplifying the differential voltage between the voltage depending on the accumulated positive weight charges and the voltage depending on the accumulated negative weight charges. For example, a differential amplifier or the like having an arbitrary configuration may be provided in the neuron circuit 10.

In this embodiment, the neuron circuit 10 accumulates charges corresponding to the product values generated by the plurality of multiplication units and outputs a multiply-accumulate result signal representing a sum of the product values on the basis of the accumulated charges.

The accumulation unit 11 included in the neuron circuit 10 functions as an accumulation unit that accumulates a charge corresponding to a product value output to the output line by each of the plurality of multiplication units.

Moreover, the capacitor 14a and the capacitor 14b function as a positive charge accumulation unit and a negative charge accumulation unit.

Moreover, in this embodiment, a charging unit is configured and charges, after the input period T, the accumulation unit 11 (capacitors 14) in which charges corresponding to product values are accumulated.

It should be noted that in a case where the electrical signal according to the TACT method is used, accumulating charges in the capacitors 14 with pulse signals whose ON level is maintained is also included in charging according to the present technology.

The signal output unit 12 functions as an output unit that performs, after the charging unit starts charging, threshold determination on the voltage retained by the accumulation unit 11 with a predetermined threshold value, to thereby output a multiply-accumulate result signal including the information regarding the timing, which corresponds to the sum of the product values obtained by multiplying the input values by the weight values.

The signal output unit 12 performs threshold determination with respect to each of the positive charge accumulation unit and the negative charge accumulation unit, to thereby output the multiply-accumulate result signal. The multiply-accumulate result signal is output from the single output signal line 13.

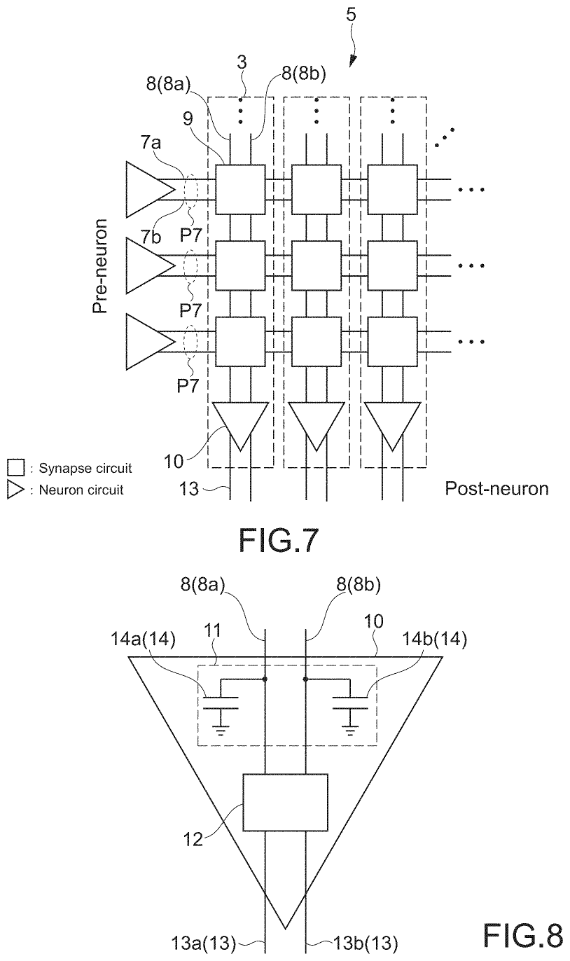

FIG. 7 is a schematic diagram showing a configuration example of the arithmetic circuit unit 5 provided as one layer in the arithmetic apparatus 200 having the two-input two-output configuration.

The arithmetic circuit unit 5 includes a plurality of input signal line pairs P7 and a plurality of analog circuits 3.

A signal pair corresponding to the input value xᵢ is input into each of the plurality of input signal line pairs P7 within the predetermined input period T. For example, the signal pair according to the PWM method or the TACT method described with reference to FIG. 4 is input into each input signal line pair P7 during the input period T.

Each input signal line pair P7 includes a positive input signal line 7a and a negative input signal line 7b. The positive input signal line 7a is a signal line into which a positive signal is input. The negative input signal line 7b is a signal line into which a negative signal is input. In this embodiment, the positive input signal line 7a corresponds to a positive input line and the negative input signal line 7b corresponds to a negative input line.

The synapse circuit 9 calculates a product value (wᵢ*xᵢ) of the input value xᵢ represented by the signal pair and the weight value wᵢ. More specifically, the product value (wᵢ*xᵢ) is calculated by multiplying each of the respective signal values (the positive value xᵢ⁺ and the absolute value |xᵢ⁻| of the negative value xᵢ⁻) of the positive and negative signals included in the signal pair by the corresponding weight value.

A positive weight value vᵢ⁺ and a negative weight value vᵢ⁻ are respectively set to the plurality of synapse circuits 9. Here, the positive weight value vᵢ⁺ is a positive real number (vᵢ⁺>0). Moreover, the negative weight value vᵢ⁻ is a negative real number (vᵢ⁻<0).

Thus, it can be said that the synapse circuit 9 is a weight pair to which the positive and negative weight values vᵢ⁺ and vᵢ⁻ are set.

The synapse circuit 9 calculates a product value of a signal value of one electrical signal included in the signal pair and the positive weight value vᵢ⁺.

Moreover, the synapse circuit 9 calculates a product value of a signal value of the other electrical signal and the negative weight value vᵢ⁻. Specifically, the synapse circuit 9 generates each of charges (currents) corresponding to the respective product values.

An electrical signal to be multiplied by the positive weight value vᵢ⁺ is set as appropriate for each synapse circuit 9. Moreover, an electrical signal that is not the electrical signal set to be multiplied by the positive weight value vᵢ⁺ is to be multiplied by the negative weight value vᵢ⁻.

Hereinafter, the product value of the positive weight value vᵢ⁺ will be referred to as a positive weight product value and the charge corresponding to the positive weight product value will be referred to as a positive weight charge. Moreover, the product value of the negative weight value vᵢ⁺ will be referred to as a negative weight product value, and the charge corresponding to the negative weight product value will be referred to as a negative weight charge.

As described above, the synapse circuit 9 is capable of generating each of a positive weight charge corresponding to a positive weight product value obtained by multiplying a signal value of one signal of a signal pair input into the input signal line pair P7 connected thereto by the positive weight value vᵢ⁺, and a negative weight charge corresponding to a negative weight product value obtained by multiplying a signal value of the other signal by the negative weight value vᵢ⁻.

It should be noted that in the synapse circuit 9, a charge with the same sign (e.g., a positive charge) is output as the charge corresponding to each product value irrespective of whether the weight value is positive or negative. That is, the positive weight charge and the negative weight charge are charges with the same sign.

Thus, it can be considered that in an actual circuit, the absolute value |vᵢ⁻| of the negative weight value vᵢ⁻ is multiplied as the negative weight value vᵢ⁻, for example. Since the positive and negative weight values can be thus handled as the values with the same sign, the circuit configuration can be simplified.

In this embodiment, the positive weight value vᵢ⁺ and the absolute value |vᵢ⁻| of the negative weight value vᵢ⁻ are set to be equal to each other for each of the plurality of synapse circuits 9.

Specifically, the positive weight value vᵢ⁺ and the absolute value |vᵢ⁻| of the negative weight value vᵢ⁻ are both set to be equal to each other as an absolute value |wᵢ| of the weight value wᵢ. That is, each weight value satisfies the relationship of |wᵢ|=vᵢ⁺=|vᵢ⁻|. Hereinafter, the weight value wᵢ will be referred to as a paired weight value wᵢ in some cases.

In the synapse circuit 9, either a paired weight value wᵢ⁺ that is a positive value or a paired weight value wᵢ⁻ that is a negative value is set as the paired weight value wᵢ.

The positive and negative paired weight values wᵢ⁺ and wᵢ⁻ can be set by relating the signal pair (positive and negative signals) to the weight pair (positive weight values) as appropriate.

Hereinafter, the synapse circuit 9 to which the positive paired weight value wᵢ⁺ is set will be referred to as a positive synapse circuit 9a and a synapse circuit 9 to which the negative paired weight value wᵢ⁻ is set will be referred to as a negative synapse circuit 9b.

The positive synapse circuit 9a generates a positive weight charge by multiplying the signal value (xᵢ⁺) of the positive signal by the positive weight value vᵢ⁺ and generates a negative weight charge by multiplying the signal value (|xᵢ⁻|) of the negative signal by the negative weight value |vᵢ⁻|. Thus, the positive weight charge and the negative weight charge are charges respectively corresponding to the positive weight product value (vᵢ⁺*xᵢ⁺) and the negative weight product value (|vᵢ⁻|*|xᵢ⁻|).

In this case, a difference Δ⁺ between the positive weight product value and the negative weight product value is expressed as follows.

Δ⁺=vᵢ⁺*xᵢ⁺−|vᵢ⁻|*|xᵢ⁻|=|wᵢ|(xᵢ⁺+xᵢ⁻)=wᵢ⁺*xᵢ

Thus, the difference Δ⁺ is the product value wᵢ⁺*xᵢ of the positive paired weight value wᵢ⁺ and the input value xᵢ. That is, in the positive synapse circuit 9a, the product value wᵢ⁺*xᵢ is calculated as a difference between the positive weight charge and the negative weight charge. In this embodiment, the positive synapse circuit 9a corresponds to a first multiplication unit.

The negative synapse circuit 9b generates a positive weight charge by multiplying the signal value (|xᵢ⁻|) of the negative signal by the positive weight value vᵢ⁺ and generates a negative weight charge by multiplying the signal value (xᵢ⁺) of the positive signal by the negative weight value |vᵢ⁻|. Thus, the positive weight charge and the negative weight charge are charges respectively corresponding to the positive weight product value (|vᵢ⁻|*xᵢ⁺) and the negative weight product value (vᵢ⁺*|xᵢ⁻|).

In this case, a difference Δ⁻ between the positive weight product value and the negative weight product value is expressed as follows.

Δ⁻=|vᵢ⁻|*xᵢ⁺−vᵢ⁺*|xᵢ⁻|=−|wᵢ|(xᵢ⁺+xᵢ⁻)=wᵢ⁻*xᵢ

Thus, the difference Δ⁻ is the product value wᵢ⁻*xᵢ of the negative paired weight value wᵢ⁻ and the input value xᵢ. That is, in the negative synapse circuit 9b, the product value wᵢ⁻*xᵢ is calculated as a difference between the positive weight charge and the negative weight charge. In this embodiment, the negative synapse circuit 9b corresponds to a second multiplication unit.

It should be noted that the positive weight charge corresponding to the positive weight product value is output to the positive charge output line 8a and the negative weight charge corresponding to the negative weight product value is output to the negative charge output line 8b.

In this embodiment, a pair of input signal line 7 (input signal line pair P7) and a pair of output lines 8 are connected to a single synapse circuit 9.

That is, a signal pair is input into the single synapse circuit 9 and a charge corresponding to a product value calculated on the basis of each electrical signal is output to each output line 8a or 8b in accordance with the sign of the paired weight value wᵢ. Thus, the synapse circuit 9 is a two-input two-output circuit.

As shown in FIG. 7, a crossbar configuration in which the input signal line pairs P7 intersect with the output lines 8 can be realized also in the arithmetic apparatus 200.

Moreover, the plurality of analog circuits 3 is connected in parallel to each of the plurality of input signal line pairs P7, and therefore, for example, a signal pair can be input in parallel to each analog circuit 3 (each synapse circuit 9) and the arithmetic processing speed can be increased. As a result, excellent arithmetic operation performance can be exerted.

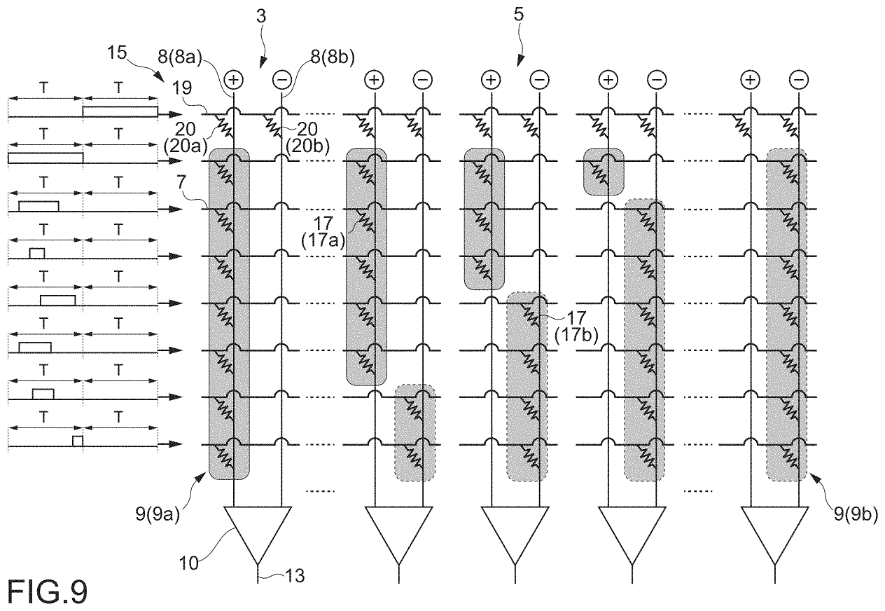

FIG. 8 is a schematic diagram showing a configuration example of the neuron circuit 10. In the arithmetic apparatus 200, a two-input two-output neuron circuit 10 connected to a pair of output lines 8 and a pair of output signal lines 13 (positive output signal line 13a and negative output signal line 13b) is configured.

A positive weight charge output as a positive multiply-accumulate signal from the positive charge output line 8a is accumulated in the capacitor 14a. Moreover, a negative weight charge output as a negative multiply-accumulate signal from the negative charge output line 8b is accumulated in the capacitor 14b. In this manner, the accumulation unit 11 is capable of accumulating the positive weight charge and the negative weight charge generated by each of the plurality of synapse circuits 9.

For example, at a timing at which the input period T of electrical signals ends, the charges accumulated in the capacitor 14a are a sum total of the positive weight charges each corresponding to the positive weight product value of the positive weight value vᵢ⁺ set to each synapse circuit 9.

Also, the charges accumulated in the capacitor 14b are a sum total of the negative weight charges each corresponding to the negative weight product value of the negative weight value vᵢ⁻ set to each synapse circuit 9.

The signal output unit 12 outputs, on the basis of the charges accumulated in the accumulation unit 11, a multiply-accumulate result signal representing a sum of the product values (wᵢ*xᵢ).

In this embodiment, a positive multiply-accumulate result signal representing a sum of positive weight product values and a negative multiply-accumulate result signal representing a sum of negative weight product values are each output as the multiply-accumulate result signal representing the sum of the product values (wᵢ*xᵢ).

Here, it is assumed that the total number of synapse circuits 9 provided in the analog circuit 3 is denoted by N. Moreover, it is assumed that out of an N-number of synapse circuits 9, the total number of synapse circuits 9 (positive weight pairs) to each of which the positive paired weight value wᵢ⁺ is set is denoted by N⁺ and the total number of synapse circuits 9 (negative weight pairs) to each of which the negative paired weight value wᵢ⁻ is set is denoted by N⁻. Thus, N=N⁺+N⁻ is established.

In this case, the multiply-accumulate result expressed by the expression (Formula 1) can be written in accordance with the above-mentioned expression (Formula 2) as in the arithmetic apparatus 100 having the one-input one-output configuration.

Since the signal pair is used in the two-input two-output arithmetic apparatus 200, the input value xᵢ is expressed as the difference between the positive value xᵢ⁺ and the absolute value of the negative value xᵢ⁻ (xᵢ=xᵢ⁺−|xᵢ⁻|). Thus, the expression (Formula 2) can be translated as follows.

$${\sum }_{i = 1}^{N} {w}_{i} \cdot {x}_{i} = \{ {\sum }_{i = 1}^{{N}^{+}} ( {w}_{i}^{+} \cdot {x}_{i}^{+} ) + {\sum }_{i = 1}^{{N}^{-}} ( \vert {w}_{i}^{-} \vert \cdot \vert {x}_{i}^{-} \vert ) \} - \{ {\sum }_{i = 1}^{{N}^{+}} ( {w}_{i}^{+} \cdot \vert {x}_{i}^{-} \vert ) + {\sum }_{i = 1}^{{N}^{-}} ( \vert {w}_{i}^{-} \vert \cdot {x}_{i}^{+} ) \} \qquad [ Formula 3 ]$$

As shown in the expression (Formula 3), the multiply-accumulate result is a value obtained by subtracting the second term from the first term. Here, the first term and the second term are terms each enclosed by the curly brackets { }.

The first term is a value obtained by adding up all positive weight product values (wᵢ⁺*xᵢ⁺) calculated in the synapse circuits 9 to each of which the positive paired weight value wᵢ⁺ is set and positive weight product values (|wᵢ⁻|*|xᵢ⁻|) calculated in the synapse circuits 9 to each of which the negative paired weight value wᵢ⁻ is set.

That is, the first term is a sum σ⁺ of the positive weight product values calculated in all the synapse circuits 9. This sum of the positive weight product values is represented by a sum of positive weight charges accumulated in the capacitor 14a.

The second term is a value obtained by adding up all negative weight product values (wᵢ⁺*|xᵢ⁻|) calculated in the synapse circuits 9 to each of which the positive paired weight value wᵢ⁺ is set and negative weight product values (|wᵢ⁻|*xᵢ⁺) calculated in the synapse circuits 9 to each of which the negative paired weight value wᵢ⁻ is set.

That is, the second term is a sum σ⁻ of negative weight product values calculated in all the synapse circuits 9. This sum of the negative weight product values is represented by a sum of negative weight charges accumulated in the capacitor 14b.

In this manner, the total multiply-accumulate result can be calculated as a difference between the sum σ⁺ of the positive weight product values and the sum σ⁻ of the negative weight product values.

It should be noted that the first term (the sum σ⁺ of the positive weight product values) in the expression (Formula 3) does not correspond to a multiply-accumulate result of an N⁺-number of positive paired weight values wᵢ⁺. Also, the second term (the sum σ⁻ of the negative weight product values) in the expression (Formula 3) does not correspond to a multiply-accumulate result of an N⁻-number of negative paired weight values wᵢ⁻.

In the example shown in FIG. 8, the signal output unit 12 refers to the charges accumulated in the capacitor 14a to thereby calculate a positive multiply-accumulate result signal representing the sum of the positive weight product values and refers to the charges accumulated in the capacitor 14b to thereby calculate a negative multiply-accumulate result signal representing the sum of the negative weight product values.

At a timing at which the input period T ends, charges corresponding to the sum of the positive weight product values (the sum of the negative weight product values) are accumulated in the capacitor 14a (14b). The same applies irrespective of whether the TACT method or the PWM method is used.

The capacitor 14a and the capacitor 14b are each charged after the input period T ends. The signal output unit 12 performs threshold determination with respect to each of the capacitors 14a and 14b, generates each of the positive multiply-accumulate result signal and the negative multiply-accumulate result signal, and outputs the positive multiply-accumulate result signal and the negative multiply-accumulate result signal to the pair of output signal lines 13 (positive output signal line 13a and negative output signal line 13b).

In this manner, the analog circuit 3 generates a pair of electrical signals (signal pair) including the positive multiply-accumulate result signal and the negative multiply-accumulate result signal. The analog circuit 3 is a circuit that outputs the total multiply-accumulate result as a signal pair.

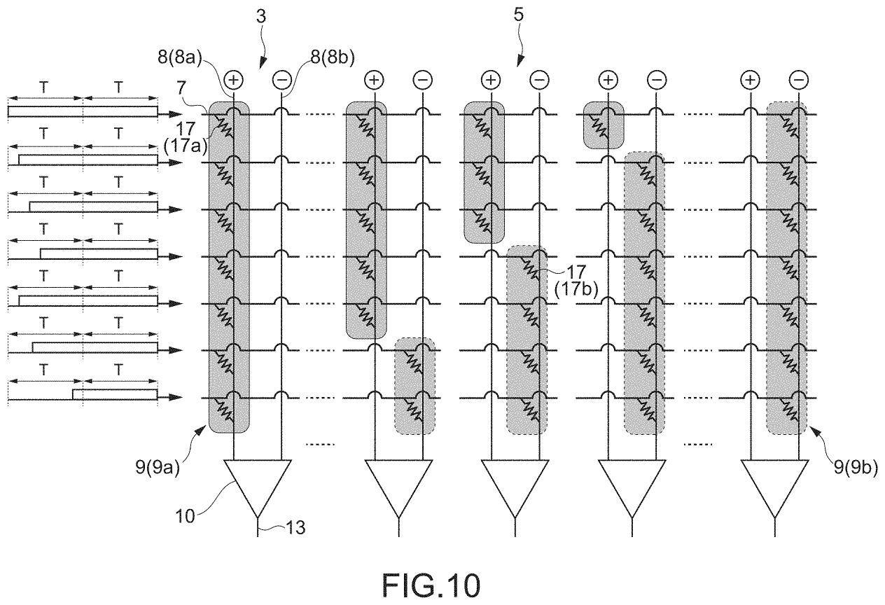

FIGS. 9 and 10 are schematic diagrams showing a configuration example of the arithmetic circuit unit 5 in the arithmetic apparatus 100 having the one-input one-output configuration.

The arithmetic circuit unit 5 illustrated in FIGS. 9 and 10 includes a plurality of input signal lines 7 and a plurality of analog circuits 3 connected in parallel to the plurality of input signal lines 7.

The analog circuits 3 are provided extending in a direction orthogonal to the plurality of input signal lines 7. That is, in the example shown in FIGS. 9 and 10, the crossbar configuration is employed.

By employing such a configuration, it is possible to input electrical signals in parallel into the respective analog circuits 3 and to achieve arithmetic processing at high speed. As a result, it is possible to exhibit excellent operation performance.

In the example shown in FIG. 9, the analog circuits 3 according to the PWM method are arranged.

The analog circuit 3 includes a pair of output lines 8 (positive charge output line 8a and negative charge output line 8b), a plurality of synapse circuits (a plurality of multiplication units) 9, a neuron circuit 10, and a charging unit 15.

Pulse signals (PWM signals) each having a pulse width corresponding to the input value xᵢ are input into the plurality of input signal lines 7 as input signals. In the example shown in FIG. 9, seven input signal lines 7 are shown, though the number of input signal lines 7 is not limited. The input signals are input within the input period T having a predetermined duration.

The positive charge output line 8a outputs the positive weight charges corresponding to the product values (wᵢ⁺*xᵢ) obtained by multiplying the input values xᵢ by the positive weight values wᵢ⁺. The negative charge output line 8b outputs the negative weight charges corresponding to the product values (|wᵢ⁻|*xᵢ) obtained by multiplying the input values xᵢ by the negative weight values wᵢ⁻. In this embodiment, the pair of output lines 8 corresponds to one or more output lines.

The plurality of synapse circuits 9 is provided to be associated with the plurality of input signal lines 7, respectively. In this embodiment, one synapse circuit 9 is provided in one input signal line 7.

Each of the plurality of synapse circuits 9 includes a resistor 17 that is connected between the corresponding input signal line 7 of the plurality of input signal lines 7 and any one of the positive charge output line 8a or the negative charge output line 8b. This resistor 17 may have a non-linear characteristic and may have a function of preventing backflow of current.

A charge corresponding to the product value (wᵢ⁺*xᵢ) (or (|wᵢ⁻|*xᵢ)) is output to the output line 8a (or 7b) to which the resistor 17 is connected.

For example, in order to multiply the input value xᵢ by the positive weight value wᵢ⁺ in each synapse circuit 9, the resistor 17 (17a) is connected between the input signal line 7 and the positive charge output line 8a and the positive charge output line 8a is made to output a positive weight charge.

Such a synapse circuit 9 is a synapse circuit 9a configured as the positive weight multiplication unit that generates a positive weight charge. It can also be said that the synapse circuit 9a is a multiplication unit in which a positive weight is set.

In order to multiply the input value xᵢ by the negative weight value wᵢ⁻ in each synapse circuit 9, the resistor 17 (17b) is connected between the input signal line 7 and the negative charge output line 8b and the negative charge output line 8b is made to output a negative weight charge.

Such a synapse circuit 9 is a synapse circuit 9b configured as the negative weight multiplication unit that generates a negative weight charge. It can also be said that the synapse circuit 9b is a multiplication unit in which a negative weight is set.

A resistor having a resistance value corresponding to the weight value wᵢ to be set is used as the resistor 17. That is, the resistor 17 functions as an element that defines the weight value wᵢ in the arithmetic apparatus 100 that performs multiply-accumulate operations at the analog circuits 3.

For example, a fixed resistor element, a variable resistor element, a MOS transistor that operates in a sub-threshold region, or the like is used as the resistor 17. By using a MOS transistor that operates in the sub-threshold region as the resistor 17, for example, it is possible to reduce the power consumption. As a matter of course, another arbitrary resistor may be used.

As illustrated in FIG. 6, the neuron circuit 10 includes the accumulation unit 11 and the signal output unit 12.

The accumulation unit 11 includes the capacitor 14a that accumulates the positive weight charges generated by the synapse circuits 9a and the capacitor 14b that accumulates the negative weight charges generated by the synapse circuits 9b.

The charging unit 15 charges the accumulation unit 11 in which a sum of charges corresponding to the product values (wᵢ*xᵢ) is accumulated. In this embodiment, the charging unit 15 includes a signal source for charging (not shown), a charging line 19, and two resistors 20.

The charging line 19 is arranged in parallel to the input signal line 7.

One resistor 20a of the two resistors 20 is connected between the charging line 19 and the positive charge output line 8a. The other resistor 20b is connected between the charging line 19 and the negative charge output line 8b.

Thus, the charging line 19 is connected to the capacitor 14a of the accumulation unit 11 via the resistor 20a. Also, the charging line 19 is connected to the capacitor 14a via the resistor 20b.

Resistors having the same resistance value are used as the resistors 20a and 20b. Although the same resistors are typically used, different types of resistors having the same resistance value may be used. The specific configurations of the resistors 20a and 20b are not limited, and various types of resistors may be used as in the resistors 17. Moreover, resistors the same in type as the resistors 17 may be used as the resistors 20a and 20b or resistors different in type from the resistors 17 may be used as the resistors 20a and 20b.

The charging is performed after the input period T ends. In this embodiment, a charging signal is input via the charging line 19 after the input period T ends. That is, the same charging signal is supplied into the capacitors 14a and 14b from the charging line 19.

Accordingly, charges based on a high-level value of the charging signal and resistance values of the resistors 20a and 20b are accumulated in the capacitors 14a and 14b.

It should be noted that in this embodiment, in this embodiment, the charging unit 15 performs charging in the output period T after the input period T. Therefore, the output period T is equivalent to a charging period.

Typically, the duration of the input period T and the duration of the output period T are set to be equal to each other.

Since the resistance values of the resistors 20a and 20b are equal to each other, the capacitors 14a and 14b are charged at the same charging speed.

The charging by the charging unit 15 increases each of the potential (voltage retained by the capacitor 14a) V⁺ of the positive charge output line 8a and the potential (voltage retained by the capacitor 14b) V⁻ of the negative charge output line 8b.

After the charging unit 15 starts charging, the signal output unit 12 of the neuron circuit 10 performs threshold determination on the voltage retained by the accumulation unit 11 with a predetermined threshold value, to thereby output a multiply-accumulate result signal representing a sum of the product values (wᵢ*xᵢ).

In this embodiment, a multiply-accumulate result signal is output by performing threshold determination with respect to each of the capacitors 14a and 14b with a common threshold value.

For example, a PMW signal, which is a pulse signal the pulse width of which has been modulated, is output as the multiply-accumulate result signal.

In this manner, in this embodiment, the multiply-accumulate result signal representing the total multiply-accumulate result including the positive and negative values is calculated on the basis of the multiply-accumulate result of positive weight charges based on the positive weight charges accumulated in the capacitor 14a and the multiply-accumulate result of negative weight charges based on the negative weight charges accumulated in the capacitor 14b.

In the example shown in FIG. 10, the analog circuits 3 according to the TACT method are arranged.

In the analog circuit 3 illustrated in FIG. 10, pulse signals (TACT signals) are input as input signals at a timing corresponding to the input value xᵢ. In this embodiment, a continuous pulse signal that rises to a timing corresponding to the input value and keeps the ON level is input.

Since the ON level of the electrical signal is maintained also after the input period T ends, charges are accumulated in the capacitor 14a and the capacitor 14b of the neuron circuit 10. That is, the capacitor 14a and the capacitor 14b are charged in the output period T.

As a result, each of the potential of the positive charge output line 8a (voltage retained by the capacitor 14a) V⁺ and the potential of the negative charge output line 8b (voltage retained by the capacitor 14b) V⁻ is increased.

The signal output unit 12 of the neuron circuit 10 performs threshold determination with respect to each of the capacitors 14a and 14b with the common threshold value. As a result, the multiply-accumulate result signal is output.

That is, the multiply-accumulate result signal representing the total multiply-accumulate result including the positive and negative values is calculated on the basis of the multiply-accumulate result of positive weight charges based on the positive weight charges accumulated in the capacitor 14a and the multiply-accumulate result of negative weight charges based on the negative weight charges accumulated in the capacitor 14b.

For example, a PMW signal, which is a pulse signal the pulse width of which has been modulated, is output as the multiply-accumulate result signal.

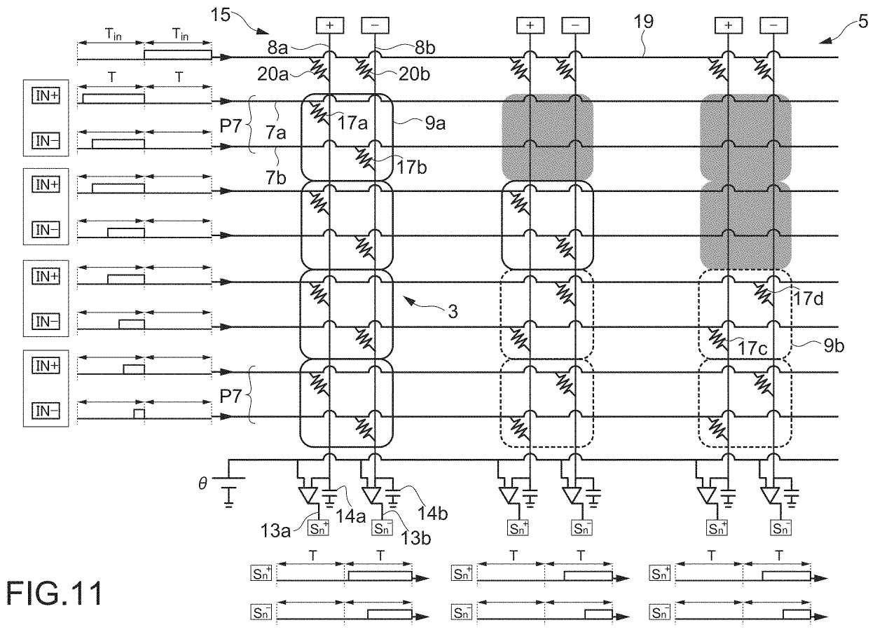

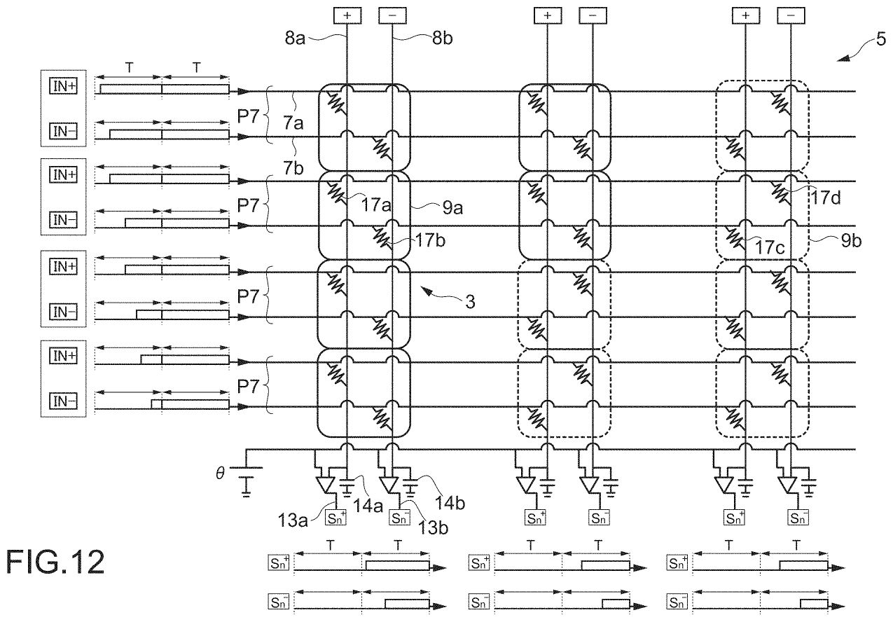

FIGS. 11 and 12 are schematic diagrams showing a configuration example of the arithmetic circuit unit 5 in the arithmetic apparatus 200 having the two-input two-output configuration.

The arithmetic circuit unit 5 illustrated in FIGS. 11 and 12 includes a plurality of input signal line pairs P7 and a plurality of analog circuits 3 connected in parallel to the plurality of input signal line pairs P7.

In the example shown in FIG. 11, the analog circuits 3 according to the PWM method are arranged.

The analog circuit 3 includes a pair of output lines 8 (positive charge output line 8a and negative charge output line 8b), a plurality of synapse circuits 9, a neuron circuit 10, and a charging unit 15.

Signal pairs are input into the plurality of input signal line pairs P7, respectively. Those signal pairs include a signal pair whose input value xᵢ is negative and a signal pair whose input value xᵢ is positive.

That is, the positive and negative input values xᵢ are transmitted by each signal pair. In the example shown in FIG. 11, the signal pair according to the PWM method is used.

The positive charge output line 8a is connected to each synapse circuit 9 and outputs the positive weight charge corresponding to the positive weight product value obtained by multiplying the signal value of either the positive signal or the negative signal by the positive weight value vᵢ⁺.

Similarly, the negative charge output line 8b is connected to each synapse circuit 9 and outputs the negative weight charge corresponding to the negative weight product value obtained by multiplying the signal value of either the positive signal or the negative signal by the absolute value |vᵢ⁻| H of the negative weight value vᵢ⁻.

The plurality of synapse circuits 9 is provided respectively corresponding to the plurality of input signal line pairs P7.

Each synapse circuit 9 is provided with two resistors 17. Those two resistors 17 each function as a weight for multiplying the weight value. Thus, the synapse circuit 9 serves as a weight pair that multiplies the signal pair by the weight value.

The plurality of synapse circuits 9 includes at least one of the positive synapse circuit 9a or the negative synapse circuit 9b.

The positive synapse circuit 9a is the synapse circuit 9 to which the positive paired weight value wᵢ⁺ is set and serves as a positive weight pair. As shown in FIG. 11, the positive synapse circuit 9a includes a first resistor 17a and a second resistor 17b.

The first resistor 17a is connected between the positive input signal line 7a and the positive charge output line 8a, defines the positive weight value vᵢ⁺, and outputs the positive weight charge to the positive charge output line 8a.

The second resistor 17b is connected between the negative input signal line 7b and the negative charge output line 8b, defines the negative weight value vᵢ⁻, and outputs the negative weight charge to the negative charge output line 8b.

Thus, in order to multiply the signal value xᵢ of the signal pair by the positive paired weight value wᵢ⁺, the positive input signal line 7a and the positive charge output line 8a are connected to each other via the resistor and the negative input signal line 7b and the negative charge output line 8b are connected to each other via the resistor.

It can also be said that regarding the positive synapse circuit 9a (positive weight pair), the positive signal (positive input) corresponds to the positive weight and the negative signal (negative input) corresponds to the negative weight.

The negative synapse circuit 9b is the synapse circuit 9 to which the negative paired weight value wᵢ⁻ is set and serves as a negative weight pair. As shown in FIG. 11, the negative synapse circuit 9b includes a third resistor 17c and a fourth resistor 17d.

The third resistor 17c is connected between the negative input signal line 7b and the positive charge output line 8a, defines the positive weight value vᵢ⁺, and outputs the positive weight charge to the positive charge output line 8a.

The fourth resistor 17d is connected between the positive input signal line 7a and the negative charge output line 8b, defines the negative weight value vᵢ⁻, and outputs the negative weight charge to the negative charge output line 8b.

Thus, in order to multiply the signal value xᵢ of the signal pair by the negative paired weight value wᵢ⁻, the negative input signal line 7b and the positive charge output line 8a are connected to each other via the resistor and the positive input signal line 7a and the negative charge output line 8b are connected to each other via the resistor.

It can also be said that regarding the negative synapse circuit 9b (negative weight pair), the positive signal (positive input) correspond to the negative weight and the negative signal (negative input) correspond to the positive weight.

As shown in FIG. 11, the positive weight (first resistor 17a) of the positive synapse circuit 9a and the positive weight (third resistor 17c) of the negative synapse circuit 9b are connected in parallel to the capacitor 14a. Those positive weights of the respective synapse circuits 9 constitute a positive weight column.

Moreover, the negative weight (second resistor 17b) of the positive synapse circuit 9a and the negative weight (fourth resistor 17d) of the negative synapse circuit 9b are connected in parallel to the capacitor 14b. Those negative weights of the respective synapse circuits 9 constitute a negative weight column.

A charging signal is input via the charging line 19 after the input period T ends. Accordingly, each of the potential of the positive charge output line 8a (voltage retained by the capacitor 14a) V⁺, and the potential of the negative charge output line 8b (voltage retained by the capacitor 14b) V⁻ is increased.

The signal output unit 12 of the neuron circuit 10 performs threshold determination with respect to each of the capacitors 14a and 14b with the common threshold value, to thereby generate each of the positive multiply-accumulate result signal and the negative multiply-accumulate result signal, and outputs the positive multiply-accumulate result signal and the negative multiply-accumulate result signal to the pair of output signal lines 13 (positive output signal line 13a and negative output signal line 13b) as a pair of electrical signals (signal pair).

In the example shown in FIG. 12, the analog circuits 3 according to the TACT method are arranged.

In the analog circuit 3 illustrated in FIG. 12, signal pairs according to the TACT method are input into the plurality of input signal line pairs P7. In this embodiment, continuous pulse signals each of which rises to a timing corresponding to the input value and keeps the ON level are input.

Charges are accumulated in the capacitor 14a and the capacitor 14b of the neuron circuit 10 because the ON level of the electrical signals is maintained also after the input period T ends. That is, the capacitor 14a and the capacitor 14b are charged in the output period T.

As a result, each of the potential of the positive charge output line 8a (voltage retained by the capacitor 14a) V⁺ and the potential of the negative charge output line 8b (voltage retained by the capacitor 14b) V⁻ is increased.

The signal output unit 12 of the neuron circuit 10 performs threshold determination with respect to each of the capacitors 14a and 14b with the common threshold value, to thereby generate each of the positive multiply-accumulate result signal and the negative multiply-accumulate result signal, and outputs the positive multiply-accumulate result signal and the negative multiply-accumulate result signal as a pair of electrical signals (signal pair) to the pair of output signal lines 13 (positive output signal line 13a and negative output signal line 13b).

In the arithmetic circuit unit 5 illustrated in FIGS. 9 to 12, the charging is performed on a common charging mode with respect to the plurality of analog circuits 3. Moreover, the threshold determination is performed with a shared threshold value in the neuron circuit 10. That is, in each analog circuit 3, the charging is performed on the same charging mode and the threshold determination is performed using the same threshold value.

Accordingly, the efficiency and speed of the arithmetic operation can be increased. As a matter of course, the multiply-accumulate operation can be performed also in a case where threshold values different from each other are used.

It should be noted that in the arithmetic apparatus 200 having the two-input two-output configuration, the positive and negative multiply-accumulate result signals can be used as they are as inputs (signal pair) to a next layer. Therefore, a difference circuit for generating positive or negative total multiply-accumulate result signals on the basis of the positive and negative multiply-accumulate result signals becomes unnecessary.

For example, such a configuration that it is sufficient to arrange only one difference circuit for generating a final multiply-accumulate result signal can be realized. As a result, the circuit configuration can be simplified, and the power consumption of the arithmetic apparatus 200 can be greatly reduced.

For example, there is a case where an MLP method is used as one of algorithms for deep-layer learning. The MLP method can provide a fully-connected configuration, for example, and does not require performing special processing and the like between a pre-stage and a post-stage of the multiply-accumulate operation.

Thus, in a case where processes of calculating positive or negative total multiply-accumulate result signals (differences between positive and negative multiply-accumulate results) after multiply-accumulate operations can be reduced, circuits and the like for difference calculation can be reduced.

In this case, an MLP network can be implemented only with a crossbar wiring structure and a comparator circuit using resistors (resistance elements) as weights without mounting unnecessary circuits. Therefore, high-speed arithmetic processing can be performed with an extremely simplified circuit configuration.

As a matter of course, the MLP method can also be realized by the use of the arithmetic apparatus having the one-input one-output configuration.

[Inference Apparatus]

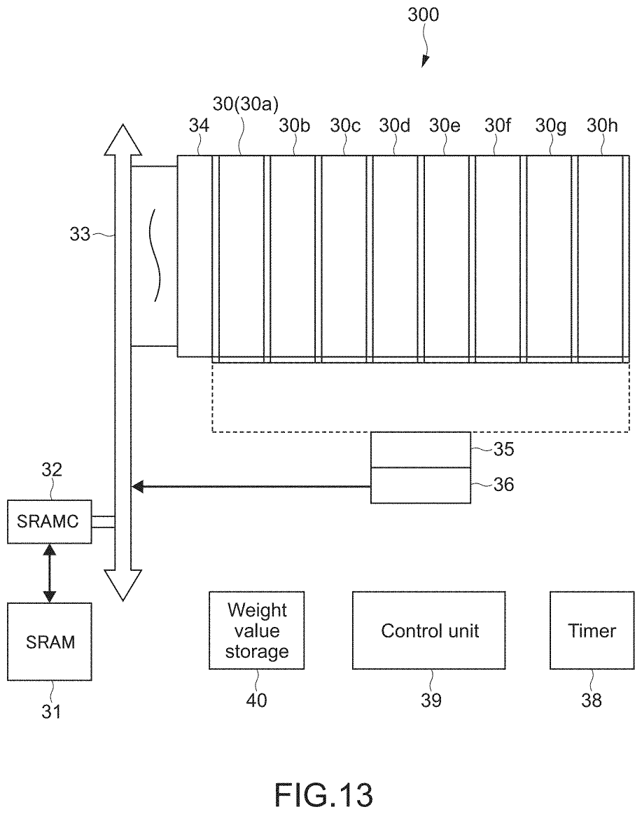

FIG. 13 is a schematic diagram showing a configuration example of an inference apparatus including the arithmetic apparatus according to the present technology. An inference apparatus 300 is an inference apparatus utilizing a neural network and is capable of realizing inference according to a convolutional neural network (CNN).

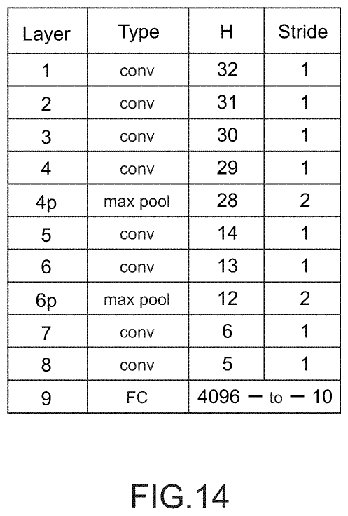

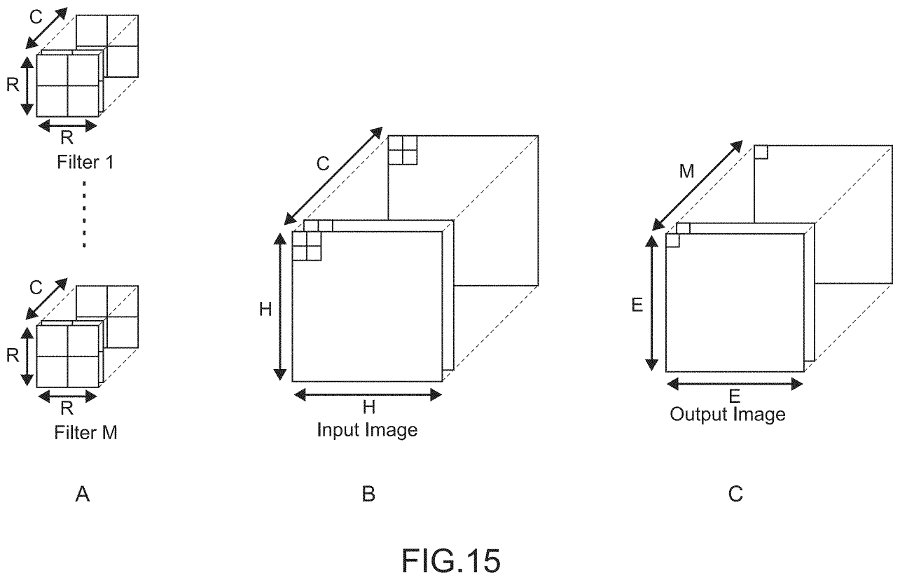

FIGS. 14 and 15 are a table and a schematic diagram for describing convolution operations performed by the inference apparatus 300.

The respective alphabets shown in FIG. 15 denote the following parameters.

H: input image size

E: output image size

R: filter size=2 (fixed)

M: number of filters=256 (fixed)

C: number of channels=256 (fixed)

As shown in FIG. 14, the CNN built in this embodiment includes eight convolutional layers, two pooling layers, and a fully connected layer.

In each convolutional layer, using with R×R×C=2×2×256 filters as shown in FIG. 15A, a convolution operation is performed with a stride=1. Since the number of filters M is 256, the convolution operation is performed through the 256 filters.

For example, in a first convolutional layer, a convolution operation is performed with a stride=1 with respect to H×H×C=32×32×256 input images as shown in FIG. 15B. E×E×C=31×31×1 output image is generated by a convolution operation through one filter. For example, a front output image in FIG. 15C is generated by a convolution operation performed through a first filter.

By performing a convolution operation through the 256 filters, E×E×M=31×31×256 output images are generated. For example, an M-th output image from the front is generated by a convolution operation through an M-th filter. As a matter of course, the present technology is not limited thereto.

As shown in FIG. 14, in each of the eight convolutional layers, a convolution operation is performed with a stride=1 through the 256 filters (R×R×C=2×2×256 filters).

Moreover, max pooling is performed in the two pooling layers.

Finally, in the fully connected layer, one of output results classified into ten results is obtained from E×E×M=4×4×256 output images (4096 pixels). For example, an analogical result indicating which one of ten kinds of animals information included in input images is is obtained. As a matter of course, the present technology is not limited thereto.

It should be noted that the processing in the two pooling layers and the fully connected layer is performed by an arithmetic unit not shown in FIG. 13.

As illustrated in FIG. 13, the inference apparatus 300 includes eight arithmetic circuit units 30 (30a to 30h), a SRAM 31, a SRAM controller (SRAMC) 32, a bus 33, and a D/A converter 34. Moreover, the inference apparatus 300 includes a multiplexer (MUX) 35, an A/D converter 36, a timer 38, a control unit 39, and a weight value storage 40.

The control unit 39 is capable of comprehensively controlling overall operations of the inference apparatus 300. The configuration of the control unit 39 is not limited, and any hardware and software may be used. For example, a programmable logic device (PLD) such as a field programmable gate array (FPGA) and other devices such as an application specific integrated circuit (ASIC) may be used.

The timer 38 supplies time (timing) information to the control unit 39. The timer 38 also supplies a time that is a reference to a clock in the D/A converter (DTC: digital-to-time converter) 34 and a clock in the A/D converter (TDC: time-to-digital converter) 36.

The specific configuration of the timer 38 is not limited.

The weight value storage 40 retains information regarding weight values set to the respective synapse circuits 9 of the eight arithmetic circuit units 30a to 30h. For example, the weight values are calculated by learning processing performed by a computer and the like (not shown) and are stored in the storage 40. As necessary, the control unit 39 reads the information regarding the weight values from the storage 40 and performs writing processing with respect to the eight arithmetic circuit units 30a to 30h.

Although not shown in FIG. 13, each of the eight arithmetic circuit units 30a to 30h is provided with a writing circuit. The writing circuit is typically electrically connected to each synapse circuit 9 via an input signal line 7 and a charge output line 8.

For example, in a case where a configuration using a volatile memory such as an SRAM is employed as the configuration for setting the weight values (the resistance values), it is necessary to perform writing every time after it is powered on.

Also, in a case where a configuration using a nonvolatile memory is employed as the configuration for setting the weight values (the resistance values), writing processing is performed in updating the weight values, for example. Moreover, the weight values can also be updated as appropriate after a predetermined number of times of inference are performed, for example.

The specific configuration of the storage 41 is not limited. Moreover, the specific configuration of the writing circuit is also not limited.

As the eight arithmetic circuit units 30a to 30h, the arithmetic circuit units 5 having the one-input one-output configuration as illustrated in FIGS. 9 and 10 or the arithmetic circuit units 5 having the two-input two-output configuration as illustrated in FIGS. 11 and 12 are used. The present technology is not limited thereto, and arithmetic circuit units having another configuration may be used.

Hereinafter, the descriptions will be given by exemplifying a case where the arithmetic circuit units 5 having the one-input one-output configuration as illustrated in FIGS. 9 and 10 are used as the eight arithmetic circuit units 30a to 30h.

The eight arithmetic circuit units 30a to 30h perform convolution operations in eight convolutional layers. The convolution operations with a stride=1 through R×R×C=2×2×256 filters as illustrated in FIG. 15 correspond to multiply-accumulate operations with respect to 1024 pieces of input data. That is, 1024 input signal lines 7 are arranged in each arithmetic circuit unit 30.

Moreover, a convolution operation through one filter corresponds to the output of a multiply-accumulate result signal through one analog circuit 3. Thus, the one analog circuit 3 is arranged for the one filter.

In this embodiment, a convolution operation is performed through the 256 filters. Thus, in each arithmetic circuit unit 30, 256 analog circuits 3 including positive charge output lines 8a and negative charge output lines 8b are arranged in parallel.

The total number of charge output lines 8 arranged so as to intersect with the plurality of input signal lines 7 is 512 (256×2).

In each analog circuit 3, the neuron circuit 10 generates a convolutional result as the multiply-accumulate result signal and outputs the multiply-accumulate result signal from the output signal line 13. Thus, 256 multiply-accumulate result signals are output as convolutional results through 256 filters from each arithmetic circuit unit 30. The 256 multiply-accumulate result signals correspond to pixel data at the same positions in the 256 output images shown in FIG. 15C.

The SRAM 31 stores 32×32×256 input images and output images generated in each convolutional layer. Moreover, the SRAM 31 stores images generated by the pooling layers and the analogical result obtained in the fully connected layer. The specific configuration of the SRAM 31 is not limited. Alternatively, another storage device may be used.

For example, a method of using two regions in the SRAM for double buffers is conceivable. For example, in a first region beginning with an address 00000, an input image, an L2 output image (output image in Layer 2), an L4 output image, an L6 output image, and an L8 output image are stored.

In a second region beginning with an address 10000, an L1 output image, an L3 output image, an L5 output image, and an L7 output image are stored.

An L1 convolution operation is performed with respect to the input image read from the first region. As a result, the output image (L1 output image) is saved in the second region. The L2 output image that is a result of an L2 convolution operation with respect to the L1 output image read from the second region is saved in the first region. In this manner, the first region and the second region may be alternately used. As a matter of course, another saving method may be used.

In accordance with an instruction from the control unit 39, the SRAMC 32 reads pixel data in an input image and an output image in each layer from the SRAM 31 and outputs the pixel data in the input image and the output image in each layer to the D/A converter 34 via the bus 33. Moreover, the SRAMC 32 receives pixel data of the convolutional result or the like and a signal of the inference result from the A/D converter 36 and writes the pixel data of the convolutional result or the like and a signal of the inference result in the SRAM 31.

The bus 33 is constituted by, for example, an address bus, a data bus, a control bus, and the like (all not shown). Pixel data for one convolution operation through 256 filters, i.e., pixel data for 2×2×256=1024 pixels is output to the D/A converter 34 via the bus 33.

Moreover, pixel data for 256 pixels, which is output from the A/D converter 36 via the bus 33, is output to the SRAMC 32.

The D/A converter 34 is constituted by 1024 D/A blocks corresponding to the pixel data for the 1024 pixels. The 1024 D/A blocks have the same configuration. Using the pixel data (pixel value) as the input value xᵢ, each D/A block generates an analog signal corresponding to the input value xᵢ as an input signal to each arithmetic circuit unit 30.

The specific configuration of the D/A converter 34 (D/A blocks) is not limited, and may be arbitrarily designed.

In this embodiment, the D/A converter 34 includes 1024 signal output lines that output 1024 input signals (analog electrical signals) corresponding to the pixel data for 1024 pixels. For example, each of the 1024 D/A blocks is provided with a signal output line.

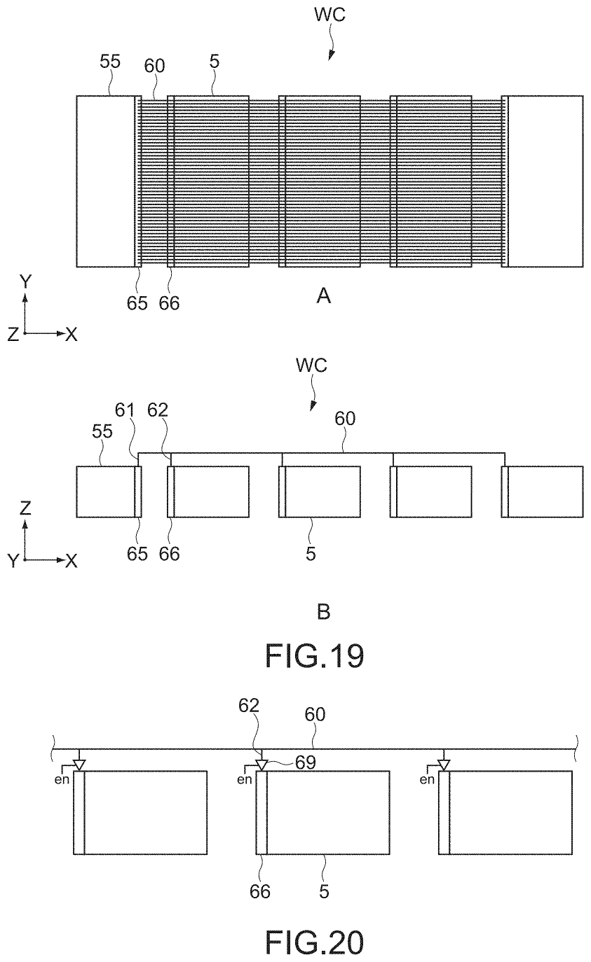

As will be described later in detail, in this embodiment, a common wiring unit WC (see FIG. 19 and the like) that electrically connects the 1024 signal output lines of the D/A converter 34 to the 1024 input signal lines 7, which each of the eight arithmetic circuit units 30a to 30h includes, is configured.

The common wiring unit WC includes a switch mechanism that outputs in a switchable manner electrical signals output from the 1024 signal output lines of the D/A converter 34 to each of the eight arithmetic circuit units 30a to 30h. This switch mechanism makes it possible to perform input switching (switching) to input the pixel data of the input image into a first arithmetic circuit unit 30a and input the L3 output image into a fourth arithmetic circuit unit 30d.

For example, a buffer capable of switching the output with an enable signal (True/False) with respect to the 1024 input signal lines 7, which each of the eight arithmetic circuit units 30a to 30h includes, is installed. Then, by controlling the buffers with enable signals, it is possible to switch the arithmetic circuit units 30 into which the output from the D/A converter 34 are input.

The specific configuration of the switch mechanism is not limited, and may be arbitrarily designed.

It should be noted that the present technology is not limited to the case where the switch mechanism is configured. Without installing the switch mechanism, the output from the D/A converter 34 may be input into all the arithmetic circuit units 30. In this case, it is sufficient to switch a signal to be input into the A/D converter 36 on the output side (in this example, through the MUX 35).

The A/D converter 36 is constituted by 256 A/D blocks corresponding to the pixel data for 256 pixels. The 256 A/D blocks have the same configuration.

Each multiply-accumulate result signal output from 256 output signal lines 13, which each of the eight arithmetic circuit units 30 includes, is converted into a digital signal through each A/D block. That is, a digital signal having a value corresponding to time information included in the multiply-accumulate result signal is generated and output.

The specific configuration of the A/D converter 36 (A/D blocks) is not limited, and may be arbitrarily designed.

In this embodiment, the A/D converter 36 includes 256 signal input lines into which the 256 multiply-accumulate result signals (analog electrical signals) corresponding to the pixel data for 256 pixels are input. For example, each of the 256 A/D blocks is provided with a signal input line.

In this embodiment, a wiring unit (not shown) that electrically connects the 256 output signal lines 13, which each of the eight arithmetic circuit units 30a to 30h includes, to the 256 signal input lines of the A/D converter 36 is configured.

The wiring unit includes a switch mechanism that switches as appropriate multiply-accumulate result signals output from the 256 output signal lines 13, which each of the eight arithmetic circuit units 30a to 30h includes, and inputs the multiply-accumulate result signals into the 256 signal input lines of the A/D converter 36.

For example, the MUX 35 illustrated in FIG. 13 functions as the switch mechanism of the wiring unit.

The MUX 35 is arranged between the eight arithmetic circuit units 30a to 30h and the A/D converter 36.

The MUX 35 is connected to the 256 output signal lines 13, which each of the eight arithmetic circuit units 30a to 30h includes. Thus, 256×8=2048 output signal lines 13 are connected. Moreover, the MUX 35 is connected to the 256 signal input lines of the A/D converter 36.

The MUX 35 is capable of switching as appropriate the output of each of the eight arithmetic circuit units 30a to 30b and inputting the output into the A/D converter 36. Accordingly, it is possible to appropriately acquires the output image in each layer.

The specific configuration of the MUX 35 is not limited, and may be arbitrarily designed. Moreover, the specific configuration of the switch mechanism is not limited, and may be arbitrarily designed.

It should be noted that the A/D converter may be set corresponding to each of the eight arithmetic circuit units 30a to 30h. That is, eight A/D converters may be arranged for the respective arithmetic circuit units 30. In this case, the common output wiring unit and the switch mechanism are unnecessary.

In a case where the arithmetic circuit units 5 having the two-input two-output configuration are used as the eight arithmetic circuit units 30a to 30h, a total number of the plurality of input signal lines 7 is 1024×2=2048. For example, 2048 D/A blocks are provided and input signals (analog electrical signals) corresponding to the pixel data are input into the 2048 input signal lines 7.

Moreover, a pair of electrical signals (signal pair) are output from each arithmetic circuit unit 30 through the pair of output signal lines 13 (positive output signal line 13a and negative output signal line 13b). Thus, 512 electrical signals (analog signals) are output from 256×2=512 output signal lines 13.

For example, 512 electrical signals (analog signals) are converted into digital data through 512 A/D blocks.

The inference apparatus 300 may be provided with an activation function such as a ReLU circuit, an enlargement circuit, and the like. Moreover, the difference circuit may be provided in a case where the arithmetic circuit units 5 having the two-input two-output configuration are used or the like.

On the basis of the difference between the positive multiply-accumulate result signal and the negative multiply-accumulate result signal, the difference circuit outputs a multiply-accumulate result signal (analog signal including time information) representing a total multiply-accumulate result signal. Accordingly, it is possible to generate digital data of the output image in each layer through the 256 A/D blocks.

Alternatively, any circuit configuration and the like may be employed.

[Operation Example During Inference]

An operation example during the inference by the inference apparatus 300 will be described.

It should be noted that it is assumed that buffers with enable have been installed for the 1024 input signal lines 7, which each of the eight arithmetic circuit units 30a to 30h includes.

By buffering input signals once when inputting into the arithmetic circuit units 30, for example, the operation accuracy of each arithmetic circuit unit 30 can be improved, and the arithmetic operation accuracy can be improved.

First of all, the enable of the buffer connected to the first arithmetic circuit unit 30a is set to be “True” and the enable for the other arithmetic circuit units 30b to 30h is set to be “False”.

Pixel data having 2×2×256=1024 pixels that correspond to the upper left out of 32×32×256 input images is read from the SRAM 31 and transferred to the D/A converter 34.

The control unit 39 instructs the D/A converter 34 to start the operation, and the input signal corresponding to the pixel data is input into the arithmetic circuit unit 30a.

Through the arithmetic circuit unit 30a, the 256 multiply-accumulate result signals are output and input into the A/D converter 36 via the MUX 35.

The A/D converter 36 generates upper left pixel data of each of 256 output images included in the L1 output image and stores the upper left pixel data in the SRAM 31.

By repeating the above-mentioned process (32−1)×(32−1)=961 times while shifting the reading position of the input image by one pixel each time, 31×31×256 L1 output images are generated and the digital data is stored in the SRAM 31.

Next, the enable of the buffer connected to a second arithmetic circuit unit 30b is set to be “True” and the enable for the other arithmetic circuit units 30a and 30c to 30h is set to be “False”.

Pixel data having 2×2×256=1024 pixels that corresponds to the upper left out of 31×31×256 L1 output images is read from the SRAM 31 and transferred to the D/A converter 34.

The control unit 39 instructs the D/A converter 34 to start the operation, and the input signal corresponding to the pixel data is input into the arithmetic circuit unit 30b.

The arithmetic circuit unit 30b outputs the 256 multiply-accumulate result signals and the 256 multiply-accumulate result signals are input into the A/D converter 36 via the MUX 35.

The A/D converter 36 generates upper left pixel data of each of 256 output images included in the L2 output image and stores the upper left pixel data in the SRAM 31.

By repeating the above-mentioned process (31−1)×(31−1)=900 times while shifting the reading position of the input image by one pixel each time, 30×30×256 L2 output images are generated and the digital data is stored in the SRAM 31.

Similarly, a third arithmetic circuit unit 30c performs an L3 convolution operation and 29×29×256 L3 output images are acquired.

A fourth arithmetic circuit unit 30d performs an L4 convolution operation and 28×28×256 L4 output images are acquired.

The arithmetic unit (not shown) performs a max pooling operation and 14×14×256 output images (that can also be referred to as L4p output images) are acquired.

A fifth arithmetic circuit unit 30e performs an L5 convolution operation and 13×13×256 L5 output images are acquired.

A sixth arithmetic circuit unit 30f performs an L6 convolution operation and 12×12×256 L6 output images are acquired.

The arithmetic unit (not shown) performs a max pooling operation and 6×6×256 output images (that can also be referred to as L6p output images) are acquired.

A seventh arithmetic circuit unit 30g performs an L7 convolution operation and 5×5×256 L7 output images are acquired.

An eighth arithmetic circuit unit 30h performs an L8 convolution operation and 4×4×256 L6 output images are acquired.

The arithmetic unit (not shown) performs on the basis of 4×4×256 L6 output images, for example, transformation processing including affine transformation and the like and a probability with respect to ten classes is calculated. Then, a class having a highest probability is output as the analogical result.

[Configuration of Common Wiring Unit]

In the inference apparatus 300 illustrated in FIG. 13, the eight arithmetic circuit units 30a to 30h are connected with respect to the one D/A converter 34. Then, the output of the D/A converter 34 is input into each of the eight arithmetic circuit units 30a to 30h.

The D/A converter 34 corresponds to an embodiment of the signal output circuit including the plurality of signal output lines capable of outputting electrical signals, respectively, according to the present technology.

Hereinafter, a new arrangement configuration in such a case where the plurality of arithmetic circuit units 5 is connected to the one signal output circuit and a new wiring configuration for electrically connecting the one signal source to the plurality of arithmetic circuit units 5 will be described. It can also be said that these arrangement configuration and wiring configuration are new arrangement configuration and wiring configuration in a case where a common signal output circuit is used for the plurality of arithmetic circuit units 5.

Hereinafter, the new arrangement configuration according to the present technology will be referred to as an arrangement configuration PC. Moreover, the new wiring configuration according to the present technology will be referred to as the common wiring unit WC.

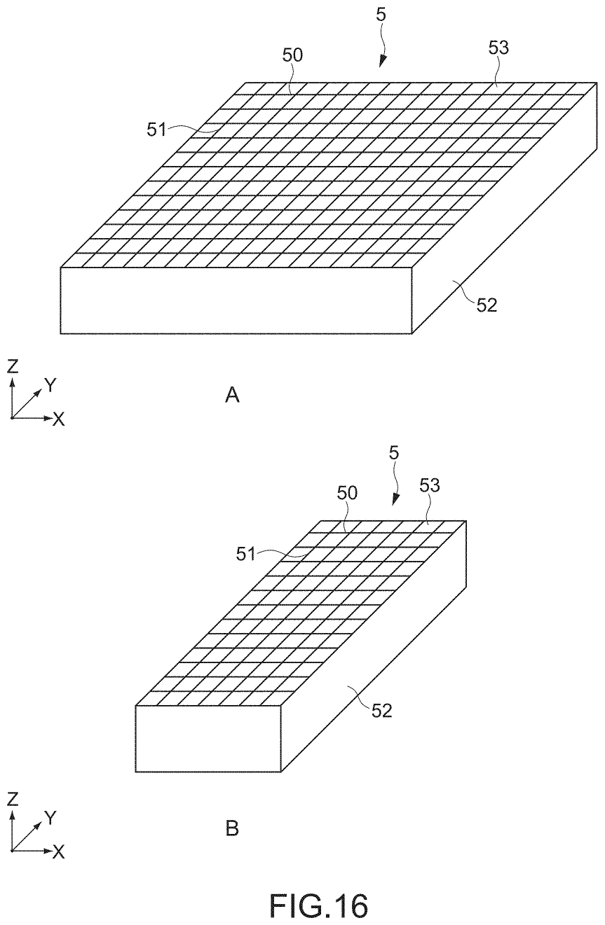

First of all, referring to FIG. 16, the “plurality of input lines”, the “plurality of output lines”, and the “reference plane” are defined with respect to the arithmetic circuit units 5 (30a to 30h).

The two arithmetic circuit units 5 shown in FIGS. 16A and B are a variant, and the method of defining the “plurality of input lines”, the “plurality of output lines”, and the “reference plane” is similar.

Hereinafter, for the sake of easy understanding of the descriptions, the descriptions will be given assuming that an X direction is a left-and-right direction, a Y direction is a depth direction, and a Z direction is an upper-and-lower direction. Moreover, the descriptions will be given assuming that an XY plane direction is a horizontal direction and a Z direction is a vertical direction.

As a matter of course, the application of the present technology is not limited to a case where such direction settings are made. For example, also a case where the X direction in the figure is the vertical direction, the present technology can be applied in a manner similar to the following descriptions.

The “plurality of input lines” is lines into each of which an electrical signal corresponding to an input value is input.

For example, in the arithmetic circuit unit 5 illustrated in FIGS. 9 and 10, the plurality of input signal lines 7 into which pulse signals corresponding to input values are input corresponds to the “plurality of input lines”.

In the arithmetic circuit unit 5 illustrated in FIGS. 11 and 12, the positive input signal line 7a and the negative input signal line 7b into which the signal pair generated in accordance with the input value is input are respectively the “plurality of input lines”.

That is, in the arithmetic apparatus 200 having the two-input two-output configuration, all the positive input signal lines 7a and the negative input signal lines 7b are the “plurality of input lines” irrespective of whether they are positive or negative.

Thus, for example, in a case where an N-number of input signal line pair P7 are arranged, a total of 2N (N×2) signal lines are the “plurality of input lines”.

Hereinafter, each of the “plurality of input lines” will be denoted by a reference sign and referred to as an input line 50. The number of input lines 50 is not limited, and may be arbitrarily designed.

The “plurality of output lines” is lines that are arranged in parallel so as to intersect with the “plurality of input lines”. That is, the “plurality of output lines” is lines that are arranged so as to have a crossbar configuration with respect to the “plurality of input lines”.

Moreover, each of the “plurality of output lines” is a line that outputs a multiply-accumulate signal generated on the basis of electrical signals input into the “plurality of input lines”.

It should be noted that the multiply-accumulate signal includes an arbitrary signal representing a sum of product values obtained by multiplying input values by weight values. For example, the multiply-accumulate signal includes a charge corresponding to a product value obtained by multiplying an input value xᵢ by a weight value wᵢ, a positive weight charge corresponding to a product value (wᵢ⁺*xᵢ) obtained by multiplying an input value xᵢ by a positive weight value wᵢ⁺, a negative weight charge corresponding to a product value (wᵢ⁻*xᵢ) obtained by multiplying an input value xᵢ by a negative weight value wᵢ⁻, and the like.

Signal lines that are a plurality of signal lines arranged in parallel so as to intersect with the “plurality of input lines” and each output a multiply-accumulate signal are the “plurality of output lines”.

For example, in the arithmetic circuit unit 5 illustrated in FIGS. 9 and 10, the positive charge output lines 8a and the negative charge output lines 8b are respectively the “plurality of output lines”. Similarly, in the arithmetic circuit unit 5 illustrated in FIGS. 11 and 12, the positive charge output lines 8a and the negative charge output lines 8b are respectively the “plurality of output lines”.

That is, both in the arithmetic apparatus 100 having the one-input one-output configuration and the arithmetic apparatus 200 having the two-input two-output configuration, all the positive charge output lines 8a and the negative charge output lines 8b are the “plurality of output lines” irrespective of whether they are positive or negative.

Thus, for example, in a case where an M-number of pairs of charge output lines 8 are arranged, a total of 2M (M×2) signal lines are the “plurality of output lines”.

Hereinafter, each of the “plurality of output lines” will be denoted by a reference sign and referred to as an output line 51. The number of output lines 51 is not limited, and may be arbitrarily designed.

The plurality of input lines 50 is arranged in parallel using a predetermined direction as an extending direction. The plurality of output lines 51 is arranged in parallel so as to intersect with the plurality of input lines 50, having a direction different from the extending direction of the plurality of input lines 50 as an extending direction.

In the example shown in FIGS. 16A and B, the plurality of input lines 50 is arranged in parallel using the X direction as the extending direction. Therefore, the extending direction of the plurality of input lines 50 is the X direction.

The plurality of output lines 51 is arranged in parallel using the Y direction different from the X direction as an extending direction. Therefore, the extending direction of the plurality of output lines 51 is the Y direction.

In the example shown in FIGS. 16A and B, the extending direction of the plurality of input lines 50 and the extending direction of the plurality of output lines 51 are orthogonal to each other. As a matter of course, the present technology is not limited thereto, and the plurality of input lines 50 and the plurality of output lines 51 may be each arranged so as to intersect with each other at an arbitrary angle.

In the present disclosure, the “extending direction” of the signal lines is a concept including a direction that is a reference for the direction in which the signal lines extend. For example, in a case where the signal lines extend straight in a predetermined direction, such a predetermined direction is the “extending direction”.

The present technology is not limited thereto. In a case where signal lines extend using a predetermined direction as the reference and are slightly deviated from the direction or slightly winding from the middle or have small steps or the like from the middle, such a predetermined direction is also the “extending direction” of the signal lines.

That is, a state in which a single direction can be determined as the direction in which the signal lines extend as all the signal lines are viewed can be referred to as a state in which the signal lines are arranged using a single direction as the “extending direction”.

In the present disclosure, the “extending direction” can be referred to as a main direction that is a reference of the direction in which the signal lines extend.

Moreover, although the arithmetic circuit units 5 (30a to 30h) are configured by incorporating circuit elements such as wires and transistors and the like in a silicon substrate or the like, the specific configuration is not limited, and may be arbitrarily designed.

With respect to such arithmetic circuit units 5, the surfaces on which the plurality of input lines 50 and the plurality of output lines 51 defined above are arranged are defined as reference planes 53.

In the example shown in FIG. 16, a portion having a rectangular parallelepiped shape is schematically shown as a substrate 52 on which the arithmetic circuit unit 5 is configured. Then, the plurality of input lines 50 and the plurality of output lines 51 are arranged on its upper surface. Thus, the upper surface of the substrate 52 corresponds to the reference plane 53.

As a matter of course, the present technology is not limited thereto, and a case where wires are arranged and the plurality of input lines 50 and the plurality of output lines 51 are arranged on the lower surface of the substrate 52 or inside of the substrate 52 is also possible.

In any case, the surface on which the plurality of input lines 50 and the plurality of output lines 51 are arranged is defined as the reference plane 53 of the arithmetic circuit unit 5.

The reference plane 53 can be arbitrarily set with respect to the inside of a three-dimensional space.

Hereinafter, in the drawings of the present disclosure, the arithmetic circuit unit 5 is sometimes schematically shown as a rectangular parallelepiped shape. In that case, it is assumed that the surface on the upper surface side represents the reference plane 53.

It should be noted that the surface on which the plurality of input lines 50 is arranged and the surface on which the plurality of output lines 51 is arranged can be different surfaces in the upper-and-lower direction (Z direction). In such a case, for example, by defining the surface on which the plurality of input lines 50 is arranged or the surface on which the plurality of output lines is arranged as the reference plane 53, the present technology can be carried out in a manner as described below.

[Arrangement Configuration PC]

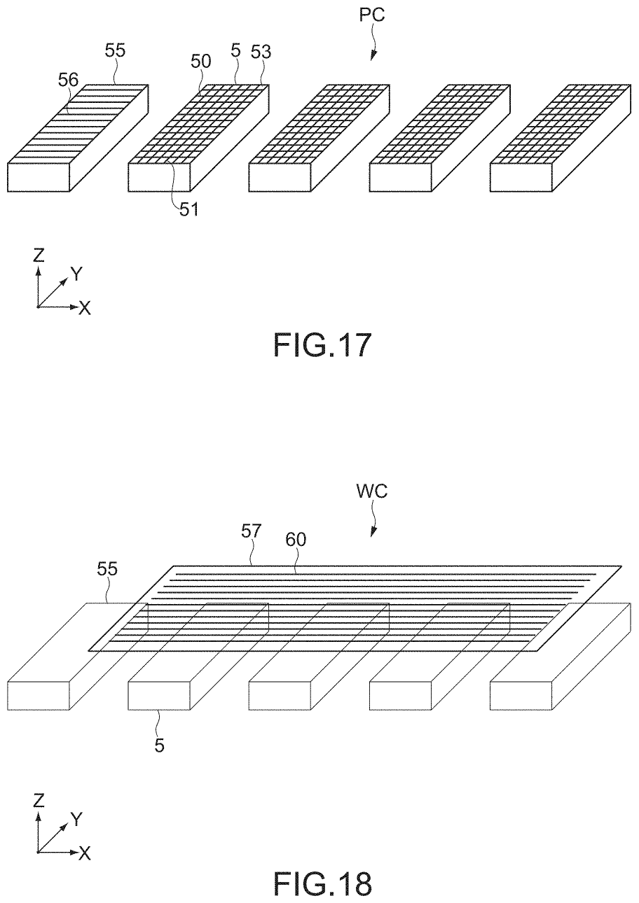

FIG. 17 is a schematic diagram showing an example of the arrangement configuration PC. In the example shown in FIG. 17, one signal output circuit 55 and four arithmetic circuit units 5 are shown.

The signal output circuit 55 includes a plurality of signal output lines 56. The plurality of signal output lines 56 of the signal output circuit 55 is arranged in parallel and extends in the identical direction.

Electrical signals output from the plurality of signal output lines 56 of the signal output circuit 55 are input into the plurality of input lines 50, which each of the four arithmetic circuit units 5 includes, as electronic signals corresponding to the input values via the common wiring unit WC (see FIG. 19 and the like).

The newly devised arrangement configuration PC has a configuration in which the extending directions of the pluralities of output lines 51 of at least two arithmetic circuit units 5 of the plurality of arithmetic circuit units 5 are parallel to each other.

Such two arithmetic circuit units 5 correspond to an embodiment of the “first arithmetic circuit unit” and the “second arithmetic circuit unit” according to the present technology.

That is, the arrangement configuration PC has a configuration in which the extending direction of the plurality of output lines 51 of the “first arithmetic circuit unit” and the extending direction of the plurality of output lines 51 of the “second arithmetic circuit unit” are parallel to each other.

In the example shown in FIG. 17, the extending directions of the pluralities of output lines 51, which the four arithmetic circuit units 5 respectively include, are all parallel to the Y direction. That is, the extending directions of the pluralities of output lines 51 of all the arithmetic circuit units 5 are parallel to each other.

It can also be said that this configuration is a configuration in which arbitrary two arithmetic circuit units of the four arithmetic circuit units 5 are the “first arithmetic circuit unit” and the “second arithmetic circuit unit”.

Moreover, in a case where arbitrary one arithmetic circuit unit of the four arithmetic circuit units 5 is used as the “first arithmetic circuit unit”, it can also be said that it is a configuration in which the extending direction of the plurality of output lines 51 which each of the plurality of arithmetic circuit units 5 includes are parallel to the extending direction of the plurality of output lines 51 of the “first arithmetic circuit unit”.

Moreover, the arrangement configuration PC illustrated in FIG. 17 has the following configuration.

The configuration in which the extending directions of the pluralities of input lines 50, which the four arithmetic circuit units 5 respectively include, are parallel to each other. It can also be said that this configuration is a configuration in which the extending direction of the plurality of input lines 50 of the “first arithmetic circuit unit” and the extending direction of the plurality of input lines 50 of the “second arithmetic circuit unit” are parallel to each other.

The configuration in which the reference planes 53 of the four arithmetic circuit units 5 are disposed to be arranged side by side on the identical plane. In the example shown in FIG. 17, the four arithmetic circuit units 5 are arranged such that the reference planes 53 are arranged side by side on a predetermined horizontal plane (XY plane).

It can also be said that this configuration is a configuration in which the four arithmetic circuit units 5 are disposed to be arranged side by side on the identical plane.

Moreover, the respective reference planes 53 of the four arithmetic circuit units 5 are disposed to be arranged side by side in a predetermined direction. In the example shown in FIG. 17, the reference planes 53 are arranged side by side in the extending directions (X direction) of the pluralities of input lines 50, which the four arithmetic circuit units 5 respectively include. It can also be said that the four arithmetic circuit units 5 are arranged side by side in the extending directions of the pluralities of input lines 50, which the four arithmetic circuit units 5 respectively include.

It should be noted that the direction in which the respective reference planes 53 of the four arithmetic circuit units 5 (four arithmetic circuit units 5) are arranged side by side is not limited. For example, a case where the reference planes 53 (arithmetic circuit units 5) are arranged side by side in the extending directions (Y direction) of the pluralities of output lines 51, which the four arithmetic circuit units 5 respectively include, is also possible.

Here, the reference plane of the “first arithmetic circuit unit” is set as the “first reference plane” and the reference plane of the “second arithmetic circuit unit” is set as the “second reference plane”.

In the example shown in FIG. 17, arbitrary two arithmetic circuit units 5 of the four arithmetic circuit units 5 can be the “first arithmetic circuit unit” and the “second arithmetic circuit unit”.

It can also be said that the arrangement configuration PC shown in FIG. 17 is a configuration in which the “first reference plane” and the “second reference plane” are disposed to be arranged side by side on the identical plane. Moreover, it can also be said that the arrangement configuration PC is a configuration in which the “first reference plane” and the “second reference plane” are disposed to be arranged side by side in the extending directions (X direction) of the pluralities of input lines 50, which the four arithmetic circuit units 5 respectively include.

Moreover, the arrangement configuration PC illustrated in FIG. 17 has a configuration in which the extending direction of the plurality of signal output lines 56 of the signal output circuit 55 is parallel to the extending directions (X direction) of the pluralities of input lines 50, which the four arithmetic circuit units 5 respectively include.

It can also be said that this configuration is a configuration in which the extending direction of the plurality of signal output lines 56 of the signal output circuit 55 is parallel to the extending direction of the plurality of input lines 50 of the “first arithmetic circuit unit”.

In this manner, the arrangement configuration PC illustrated in FIG. 17 includes various configurations. The present technology is not limited to a case of including these configurations. For example, a case where or the like including only a configuration in which the extending direction of the plurality of output lines 51 of the “first arithmetic circuit unit” and the extending direction of the plurality of output lines 51 of the “second arithmetic circuit unit” are parallel to each other is also possible.

[Common Wiring Unit WC]

FIGS. 18 and 19 are schematic diagrams showing an example of the common wiring unit WC configured for the arrangement configuration PC illustrated in FIG. 17. FIG. 19A is a schematic diagram as the common wiring unit WC is viewed from the side in the depth direction. FIG. 19B is a schematic diagram as the common wiring unit WC is viewed from above in the vertical direction (Z direction).

The common wiring unit WC electrically connects the plurality of signal output lines 56 of the signal output circuit 55 to the plurality of input lines 50 which each of the plurality of arithmetic circuit units 5 includes.

In this embodiment, the common wiring unit WC is configured using as a reference a wiring reference plane 57 set on the basis of the positional relationship between the “first arithmetic circuit unit” and the “second arithmetic circuit unit”. For example, the wiring reference plane 57 is set on the basis of a positional relationship between the “first reference plane” of the “first arithmetic circuit unit” and the “second reference plane” of the “second arithmetic circuit unit”.

As shown in FIG. 18, in this embodiment, the wiring reference plane 57 is set on the basis of a positional relationship between the four arithmetic circuit units 5. That is, the wiring reference plane 57 is set on the basis of each of the reference planes 53 of the positional relationship between the four arithmetic circuit units 5.

In this embodiment, the wiring reference plane 57 is set to be parallel to an identical plane (horizontal plane) in which the four reference planes 53 are arranged. It can also be said that the wiring reference plane 57 is set to be parallel to the identical plane (horizontal plane) in which the four arithmetic circuit units 5 are arranged. Moreover, in this example, it corresponds to a case where the wiring reference plane 57 is set such that the identical plane (horizontal plane) in which the “first reference plane” and the “second reference plane” are arranged is parallel.

As shown in FIG. 18, in this embodiment, the wiring reference plane 57 is set on the upper side of the four arithmetic circuit units 5.

As shown in FIGS. 18 and 19, in this embodiment, the common wiring unit WC includes a plurality of reference wires 60, a plurality of output-side wires 61, and a plurality of input-side wires 62. The number of each of the plurality of reference wires 60, the plurality of output-side wires 61, and the plurality of input-side wires 62 is typically equal to the number of electrical signals (number of input signals) input into each arithmetic circuit unit 5.

That is, the number of each of the plurality of reference wires 60, the plurality of output-side wires 61, and the plurality of input-side wires 62 is equal to the number of the plurality of input lines 50 of each arithmetic circuit unit 5.

The plurality of reference wires 60 is arranged in parallel and extends in the identical direction on the wiring reference plane 57. The extending direction of the plurality of reference wires 60 is set to be parallel to the direction in which the “first reference plane” and the “second reference plane” are arranged side by side.

In this embodiment, the extending direction of the plurality of reference wires 60 is set to be parallel to the direction in which the reference planes 53 of the four arithmetic circuit units 5 are arranged side by side, i.e., the extending directions (X direction) of the pluralities of input lines 50, which the four arithmetic circuit units 5 respectively include.

Therefore, the plurality of reference wires 60 is arranged in the horizontal direction.

As shown in FIG. 19B, the plurality of output-side wires 61 electrically connects the plurality of signal output lines 56 of the signal output circuit 55 to the plurality of reference wires 60.

In FIGS. 19A and B, the output end portion 65 of the signal output circuit 55 is schematically shown.

The output end portion 65 of the signal output circuit 55 is a circuit configuration including output-side end portions of the plurality of signal output lines 56 of the signal output circuit 55. As shown in FIG. 19B, the plurality of output-side wires 61 is connected to output end portions 65. Accordingly, the plurality of output-side wires 61 is electrically connected to the plurality of signal output lines 56. The specific configurations of the output end portions 65 are not limited.

In this embodiment, the plurality of output-side wires 61 is arranged upward in the vertical direction from the output end portion 65 of the signal output circuit 55.

As shown in FIG. 19B, the plurality of input-side wires 62 electrically connects the plurality of reference wires 60 to the plurality of input lines 50 of each arithmetic circuit unit 5.

In FIGS. 19A and B, an input end portion 66 of each arithmetic circuit unit 5 is schematically shown.

The input end portion 66 of each arithmetic circuit unit 5 is a circuit configuration including input-side end portions of the plurality of input lines 50 of each arithmetic circuit unit 5. As shown in FIG. 19B, the plurality of input-side wires 62 is connected to the input end portion 66. Accordingly, the plurality of input-side wires 62 is electrically connected to the plurality of input lines 50. The specific configuration of the input end portion 66 is not limited.

In this embodiment, the plurality of input-side wires 62 is arranged facing the input end portion 66 of each arithmetic circuit unit 5 from above in the vertical direction.

As illustrated in FIGS. 18 and 19, in this embodiment, the plurality of output-side wires 61 is arranged in the vertical direction from the signal output circuit 55. Moreover, on the upper side of the four arithmetic circuit units 5, the plurality of reference wires 60 is arranged in the horizontal direction in the direction in which the four arithmetic circuit units 5 are arranged side by side. Moreover, input-side wires 62 are arranged facing each arithmetic circuit unit 5 from the reference wires 60 in the vertical direction.

Accordingly, as the wires from the signal output circuit 55 to each of the four arithmetic circuit units 5 are viewed, it is possible to make the wire lengths from the signal output circuit 55 to the respective arithmetic circuit units 5 equal, and it is also possible to reduce the wire lengths.

For example, referring to FIG. 19, as the wires from the signal output circuit 55 to the leftmost arithmetic circuit unit 5 are viewed, it is possible to make the wire lengths equal, and it is also possible to reduce the wire lengths. Moreover, also as the wires from the signal output circuit 55 to the rightmost arithmetic circuit unit 5 are viewed, it is possible to make the wire lengths equal, and it is also possible to reduce the wire lengths. The same applies to the wires to the other arithmetic circuit units 5.

Making the wire lengths from the signal output circuit 55 to the respective arithmetic circuit units 5 equal leads to making the parasitic capacitances, which are produced due to the wiring units, equal. Accordingly, delay times of analog signals can be made to equal, and transmission errors of analog signals can be reduced.

Since information is transmitted using a timing (point of time) or a pulse width (period of time) especially in a time-axis analog multiply-accumulate method, the arithmetic operation accuracy can be greatly improved by reducing irregularities in the delay time.

Moreover, the wire lengths from the signal output circuit 55 to the respective arithmetic circuit units 5 can be shortened, and therefore the timing delay compensation by external circuits can be reduced. As a result, the latency can be shortened.

Moreover, it is also advantageous to set the inputs into each arithmetic circuit unit 5 to have the same condition because the wire lengths can be shortened.

It should be noted that there can also be a case where all the wire lengths from the signal output circuit 55 to the respective arithmetic circuit units 5 are not equal. Moreover, there can also be a case where all the wire lengths are not precisely equal and have some irregularities in the length.

However, by employing the newly devised arrangement configuration PC and common wiring unit WC, it is possible to set many wires from the end portions of the output lines 66a to the end portions of the input lines 65b to be equal or set many wires from the signal output circuit 55 to the respective arithmetic circuit units 5 to be variable in a sufficiently small range using a predetermined length as a reference. As a result, the above-mentioned effects can be sufficiently exerted.

It can also be said that the equal-length wiring configuration according to the present technology is a technology that enables, in the arithmetic apparatus that configures the plurality of arithmetic circuit units 5 according to the analog method that inputs and outputs analog signals into/from the common signal output circuit 55, the wires between the signal output circuit 55 to each arithmetic circuit unit 5 to be set to have an equal length (equal capacity, equal delay time) and to be shortened by imposing a suitable limitation on the arrangement of the plurality of arithmetic circuit units 5 and constructing the common wiring unit WC as appropriate.

The method for realizing the common wiring unit WC is not limited, and any technology may be used. For example, with the laminate structure of the substrate, the wiring layer is configured via the insulating film and the like and the reference wires 60 are formed. Then, vertical wires to the wiring layer are configured with vertical via-holes and the like and the output-side wires 61 and the input-side wires 62 are formed. Alternatively, any technology may be used.

It should be noted that the wiring reference plane 57 may be set on the lower side of the four arithmetic circuit units 5.

In this embodiment, the output-side wiring unit 61 corresponds to the “first wiring unit”. Moreover, the input-side wires 62 correspond to a “second wiring unit” and a “third wiring unit”.

As shown in FIG. 19A, in this embodiment, the output-side wiring unit 61 and the input-side wires 62 extend in the identical direction (Z direction). Thus, in this embodiment, the “first wiring unit”, the “second wiring unit”, and the “third wiring unit” extend in the identical direction.

FIG. 20 is a schematic diagram showing an example of the switch mechanism provided in the common wiring unit WC.

As shown in FIG. 20, a buffer 69 with enable described above is arranged in each of the input-side wires 62. By controlling the buffers 69 with enable signals, it is possible to output electrical signals output from the plurality of signal output lines 56 of the signal output circuit 55 to each of the four arithmetic circuit units 5 in a switchable manner.

A switch mechanism including the buffers 69 with the enable correspond to an embodiment of the “switch unit” according to the present technology. The specific configuration of the “switch unit” is not limited, and may be arbitrarily designed. For example, the output-side wires 61 may be provided with buffers with enable or the like.

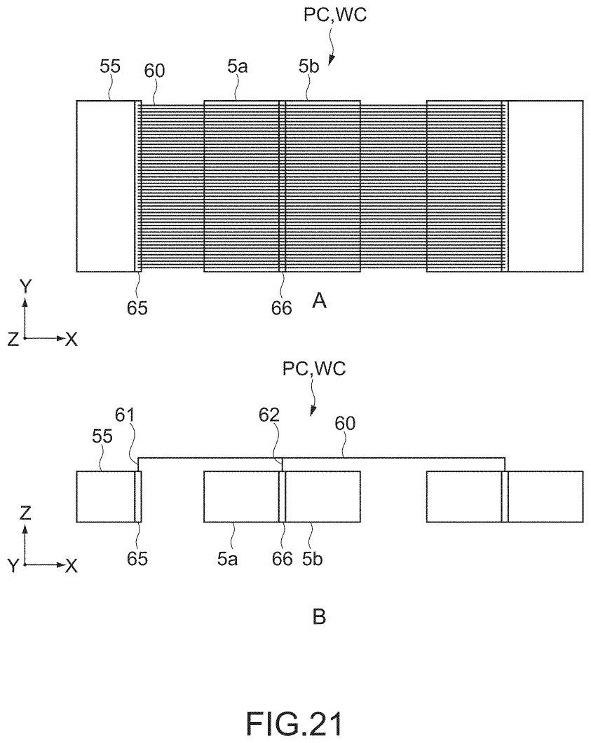

FIG. 21 is a schematic diagram showing another configuration example of the arrangement configuration PC and the common wiring unit WC.

In the example shown in FIGS. 21A and B, the arrangement configuration PC includes an arrangement configuration in which the input-side end portions of the plurality of input lines 50 face each other in opposite to each other in the adjacent arithmetic circuit units 5a and 5b.

For example, regarding the leftmost arithmetic circuit unit 5a, the input-side end portions are arranged on the right side and input signals are input from the right side to the left side. Regarding the second arithmetic circuit unit 5b adjacent to the arithmetic circuit unit 5a on the leftmost side, the input-side end portions are arranged on the left side and input signals are input from the left side to the right side.

By employing such an arrangement, it is possible to commonly configure the input end portion 66 for the two arithmetic circuit units 5a and 5b arranged facing each other. Moreover, it is possible to commonly configure the input-side wires 62 that electrically connect the reference wires 60 to the pluralities of input lines 50, which the two arithmetic circuit units 5a and 5b respectively include.

That is, it is possible to reduce the number of vertical via-holes (vertical wires), and simplification of the structure and a reduction of the component costs can be achieved.

It should be noted that a switch mechanism or the like capable of switching the signal input into the two arithmetic circuit units 5a and 5b may be installed in the commonly configured input-side wires 62.

As the two arithmetic circuit units 5a and 5b are viewed as the “first arithmetic circuit unit” and the “second arithmetic circuit unit”, the input-side wires 62 arranged facing the two arithmetic circuit units 5a and 5b correspond to an embodiment of the “second wiring unit” and the “third wiring unit” constituted by the identical wiring unit.

That is, in the configuration shown in FIG. 21, the “second wiring unit” and the “third wiring unit” are constituted by the identical wiring unit.

It should be noted that in both the configuration illustrated in FIG. 19 and the configuration illustrated in FIG. 21, regarding the arithmetic circuit unit 5 on the rightmost side, the input-side end portions are arranged on the left side that is the side of the signal output circuit 55, and input signals are input into the input-side end portions from the left side to the right side. Accordingly, it is possible to reduce the lengths of the reference wires 60 arranged to the arithmetic circuit unit 5 on the rightmost side, and it is possible to reduce the wire lengths. As a result, the component costs can be reduced.

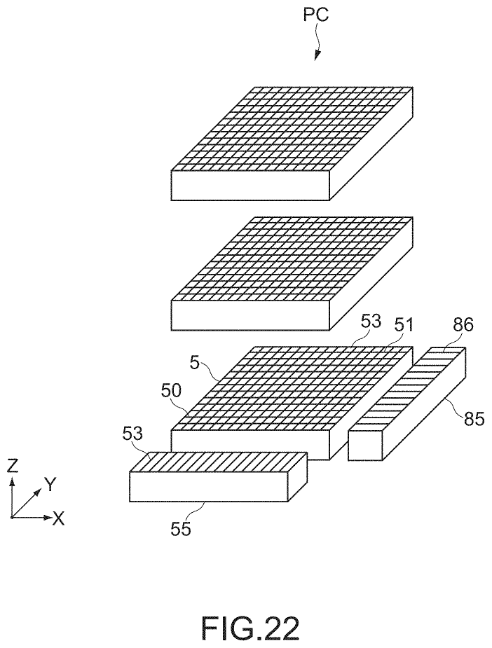

FIG. 22 is a schematic diagram showing another example of the arrangement configuration PC. In the example shown in FIG. 22, it includes one signal output circuit 55, three arithmetic circuit units 5, and one signal input circuit 85. The signal input circuit 85 will be described later.

The arrangement configuration PC shown in FIG. 22 also has a configuration in which the extending directions of the pluralities of output lines 51 of at least two arithmetic circuit units 5 of the plurality of arithmetic circuit units 5 are parallel to each other.

In the example shown in FIG. 22, the extending directions of the pluralities of output lines 51, which the three arithmetic circuit units 5 respectively include, are all parallel to the X direction. That is, the extending directions of the pluralities of output lines 51 of all the arithmetic circuit units 5 are parallel to each other.

Therefore, the arbitrary two arithmetic circuit units of the three arithmetic circuit units 5 can be equivalent to the “first arithmetic circuit unit” and the “second arithmetic circuit unit”.

Moreover, the arrangement configuration PC illustrated in FIG. 22 has the following configuration.

The configuration in which the extending directions of the pluralities of input lines 50, which the three arithmetic circuit units 5 respectively include, are parallel to each other. It can also be said that this configuration is a configuration in which the extending direction of the plurality of input lines 50 of the “first arithmetic circuit unit” and the extending direction of the plurality of input lines 50 of the “second arithmetic circuit unit” are parallel to each other.

The configuration in which the reference planes 53 of the three arithmetic circuit units 5 are arranged side by side to be orthogonal to the predetermined reference direction. In the example shown in FIG. 22, the three arithmetic circuit units 5 are arranged such that the reference planes 53 are arranged side by side to be orthogonal to the vertical direction (Z direction). That is, the vertical direction is set as the reference direction.

It can also be said that this configuration is a configuration in which the three arithmetic circuit units 5 are arranged side by side to be orthogonal to the reference direction (Z direction).

Moreover, the respective reference planes 53 of the three arithmetic circuit units 5 are disposed to be arranged side by side in the reference direction (Z direction).

It can also be said that the arrangement configuration PC shown in FIG. 22 is a configuration in which the “first reference plane” and the “second reference plane” are arranged side by side to be orthogonal to the predetermined reference direction. Moreover, it can also be said that the arrangement configuration PC shown in FIG. 22 is a configuration in which the “first reference plane” and the “second reference plane” are disposed to be arranged side by side in the predetermined reference direction.

It should be noted that the method of arranging the plurality of arithmetic circuit units 5 side by side in the vertical direction is not limited, any technology may be used. For example, a technology of configuring a three-dimensional large scale integration (LSI) can be used.

Moreover, the arrangement configuration PC illustrated in FIG. 22 has a configuration in which the extending direction of the plurality of signal output lines 56 of the signal output circuit 55 is parallel to the extending directions (Y direction) of the pluralities of input lines 50, which the three arithmetic circuit units 5 respectively include.

It can also be said that this configuration is a configuration in which the extending direction of the plurality of signal output lines 56 of the signal output circuit 55 is parallel to the extending direction of the plurality of input lines 50 of the “first arithmetic circuit unit”.

In this manner, the arrangement configuration PC illustrated in FIG. 22 includes various configurations. The present technology is not limited to a case of including these configurations. For example, a case where or the like including only a configuration in which the extending direction of the plurality of output lines 51 of the “first arithmetic circuit unit” and the extending direction of the plurality of output lines 51 of the “second arithmetic circuit unit” are parallel to each other is also possible.

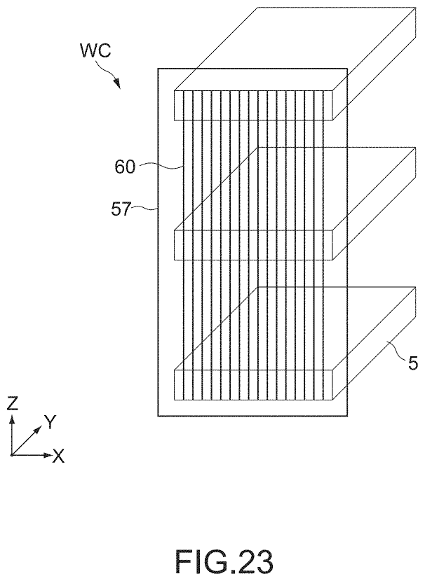

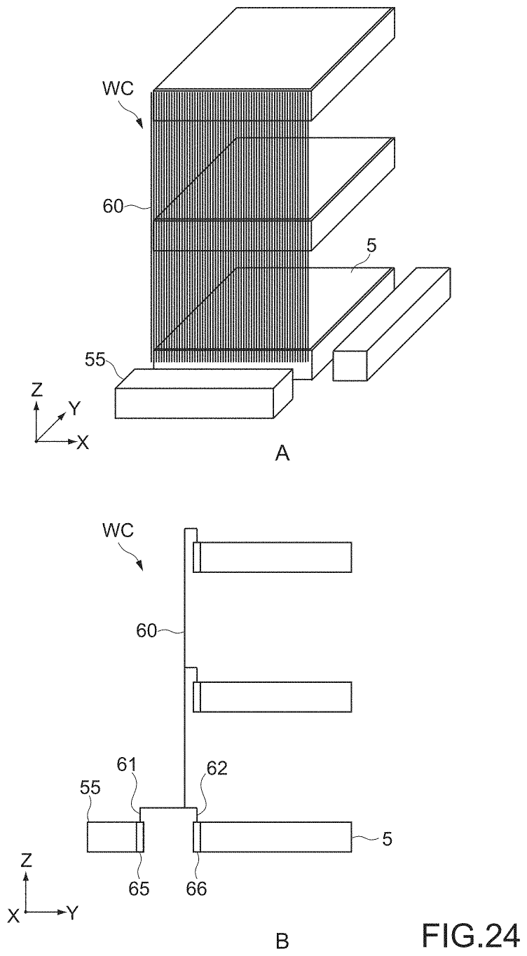

FIGS. 23 and 24 are schematic diagrams showing an example of the common wiring unit WC configured for the arrangement configuration PC illustrated in FIG. 22. FIG. 24B is a schematic diagram as the common wiring unit WC is viewed from the side in the left-and-right direction (X direction).

In this embodiment, regarding the common wiring unit WC, the wiring reference plane 57 is set on the basis of a positional relationship between the three arithmetic circuit units 5. That is, the wiring reference plane 57 is set on the basis of a positional relationship between the respective reference planes 53 of the three arithmetic circuit units 5.

The wiring reference plane 57 is set to be parallel to the reference direction (Z direction) to which the three reference planes 53 are orthogonal. Moreover, the wiring reference plane 57 is set to be parallel to the extending directions (X direction) of the pluralities of output lines 51, which the three arithmetic circuit units 5 respectively include. The extending directions of the pluralities of output lines 51, which the three arithmetic circuit units 5 respectively include, correspond to the extending direction of the plurality of output lines 51 of the “first arithmetic circuit unit”.

That is, in this embodiment, the wiring reference plane 57 is set to be parallel to a ZX plane direction. Moreover, the wiring reference plane 57 as shown in FIG. 23 is set on the side of the input-side end portions of the three arithmetic circuit units 5.

As shown in FIGS. 23 and 24, the common wiring unit WC includes a plurality of reference wires 60, a plurality of output-side wires 61, and a plurality of input-side wires 62.

The plurality of reference wires 60 is arranged in parallel and extends in the identical direction on the wiring reference plane 57. The extending direction of the plurality of reference wires 60 is set to be parallel to the reference direction (Z direction). Thus, the plurality of reference wires 60 is arranged in the vertical direction.

The plurality of output-side wires 61 is arranged between the output end portion 65 of the signal output circuit 55 and the reference wires 60.

The plurality of input-side wires 62 is arranged between the plurality of reference wires 60 and the input end portion 66 of each arithmetic circuit unit 5.

The plurality of reference wires 60 and the plurality of input-side wires 62 include vertical wires that extend in the vertical direction and horizontal wires that extend in the horizontal direction. The present technology is not limited to those configurations.

The method for realizing the common wiring unit WC is not limited, and any technology may be used.

As illustrated in FIGS. 23 and 24, in this embodiment, the plurality of reference wires 60 is arranged in the vertical direction in which the three arithmetic circuit units 5 are arranged side by side. Then, the output-side wires 61 are arranged so as to connect the signal output circuit 55 to the plurality of reference wires 60. Moreover, the input-side wires 62 are arranged so as to connect the plurality of reference wires 60 to each arithmetic circuit unit 5.

Accordingly, as wires from the signal output circuit 55 to each of the three arithmetic circuit units 5 are viewed, it is possible to make the wire lengths from the signal output circuit 55 to the respective arithmetic circuit units 5 equal, and it is also possible to reduce the wire lengths. As a result, the arithmetic operation accuracy can be greatly improved.

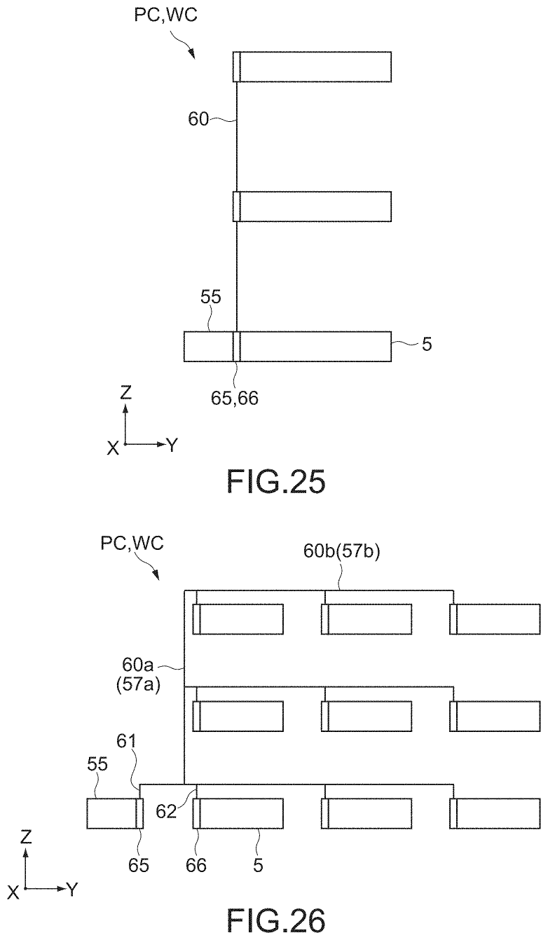

FIG. 25 is a schematic diagram showing another configuration example of the arrangement configuration PC and the common wiring unit WC.

In the arrangement configuration PC shown in FIG. 25, the output end portion 65 of the signal output circuit 55 and the input end portion 66 of the arithmetic circuit unit 5 on the lowermost side are commonly configured (hereinafter, referred to as common end portions).

The plurality of reference wires 60 that the common wiring unit WC includes is arranged so as to connect the common end portions to the input end portions of the second and third arithmetic circuit units 5.

That is, in this example, the plurality of reference wires 60 is connected to each of the output-side end portions of the plurality of signal output lines 56 of the signal output circuit 55, the input-side end portions of the plurality of input lines 50 of the “first arithmetic circuit unit”, and the input-side end portions of the plurality of input lines 50 of the “second arithmetic circuit unit”.

Accordingly, the common wiring unit WC can be realized only with the plurality of reference wires 60, and the output-side wires 61 and the input-side wires 62 can be omitted. As a result, the configuration of the common wiring unit WC can be simplified, and the component costs can be reduced.

In the arrangement configuration PC illustrated in FIGS. 17 to 21 or the arrangement configuration PC illustrated in FIGS. 22 to 25, the extending directions of the pluralities of output lines 51 of all the arithmetic circuit units 5 are parallel to each other. Thus, the arbitrary two arithmetic circuit units of the plurality of arithmetic circuit units 5 can be the “first arithmetic circuit unit” and the “second arithmetic circuit unit”.

The application of the present technology is not limited to such a configuration.

For example, it is assumed that the extending directions of the pluralities of output lines 51 of only some arithmetic circuit units 5 of the plurality of arithmetic circuit units 5 are parallel to each other and the extending directions of the pluralities of output lines 51 of the other arithmetic circuit units 5 are not parallel.

Also in this case, the arithmetic circuit units 5 in which the extending directions of the pluralities of output lines 51 are parallel to each other will be referred to as the “first arithmetic circuit unit” and the “second arithmetic circuit unit”, and the common wiring unit WC according to the present technology is configured. Accordingly, with respect to the arithmetic circuit units 5 that are the “first arithmetic circuit unit” and the “second arithmetic circuit unit”, the equal-length wiring can be realized, and the wires can be shortened. As a result, the arithmetic operation accuracy can be improved.

FIG. 26 is a schematic diagram showing another configuration example of the arrangement configuration PC and the common wiring unit WC.

In the arrangement configuration PC shown in FIG. 26, the plurality of arithmetic circuit units 5 arranged on the identical plane are stacked in the vertical direction.

Specifically, the three arithmetic circuit units 5 are arranged so as to be arranged side by side in the Y direction on the horizontal plane (XY plane). The three arithmetic circuit units 5 are stacked in three layers so as to be arranged side by side in the vertical direction.

It should be noted that it is assumed that in all the arithmetic circuit units 5, the extending directions of the pluralities of output lines 51 are parallel to the X direction.

With respect to such an arrangement configuration PC, a wiring reference plane 57a is set and a reference wire 60a is arranged so as to be parallel to the vertical direction in which the three arithmetic circuit units 5 are stacked. Moreover, a wiring reference plane 57b is set and a reference wire 60b is arranged so as to be parallel to the identical plane (XY plane) in which the three arithmetic circuit units 5 are arranged.

The output-side wires 61 are arranged so as to connect the signal output circuit 55 to the reference wires 60a and 60b. Moreover, the input-side wires 62 are arranged so as to connect the reference wires 60a and 60b to each arithmetic circuit unit 5.

In this manner, by constructing the common wiring unit WC, it is possible to make the wire lengths from the signal output circuit 55 to the respective arithmetic circuit units 5 equal, and it is also possible to reduce the wire lengths. As a result, the arithmetic operation accuracy can be greatly improved.

It can also be said that the configuration shown in FIG. 26 is a configuration in which, focusing on the direction in which the reference planes are arranged side by side in addition to the point that the extending directions of the pluralities of output lines 51 are parallel to each other, the “first arithmetic circuit unit” and the “second arithmetic circuit unit” are selected and the common wiring unit WC is configured with respect to the selected “first arithmetic circuit unit” and “second arithmetic circuit unit”.

Hereinabove, in the arithmetic apparatus according to this embodiment, the plurality of arithmetic circuit units 5 is arranged with respect to the common signal output circuit 55. By employing the above-mentioned arrangement configuration PC and the common wiring unit WC, it is possible to make the wire lengths from the signal output circuit 55 to the respective arithmetic circuit units 5 equal, and it is also possible to reduce the wire lengths. As a result, the operation accuracy can be improved in an analog circuit that performs a multiply-accumulate operation.

It should be noted that as in Patent Literature 1 described above, there have been literatures showing figures and the like for conceptionally describing transmission and the like of input signals or multiply-accumulate signals. However, there have been no literatures referring to actual physical arrangement configurations, wires, and the like in the design for a plurality of arithmetic circuit units.

For example, a case where a plurality of types of multiply-accumulate calculations are performed by rewriting the weights of a multiply-accumulate device is conceivable. In a case where an analog multiply-accumulate device utilizing a non-volatile memory for performing such multiply-accumulate calculations is used, it is necessary to arrange a plurality of multiply-accumulate devices in which weights are written respectively in order to avoid rewriting. Efficient arrangement and wiring in such a case have not been studied.

In view of this, actual circuit configurations in an arithmetic apparatus having a plurality of arithmetic circuit units have been examined. Specifically, arrangements and wires efficient in terms of electric power and the like when a plurality of analog arithmetic circuit units that inputs and outputs analog signals including time information corresponding to input values is mounted on the same chip have been examined.

As a result, the focus was placed on a plurality of input lines and a plurality of output lines arranged so as to intersect with each other, which were included in arithmetic circuit units, and the arrangement configuration PC and the common wiring unit WC according to the present technology was newly devised.

As a matter of course, the application of the present technology is not limited to the case where the plurality of analog arithmetic circuit units is mounted on the single chip. The present technology can also be applied to a case where a plurality of analog arithmetic circuit units is mounted on a plurality of chips such as stacked chips or to a three-dimensional semiconductor, and the above-mentioned effects can be exerted.

Moreover, the application of the present technology is not limited to the case where the analog multiply-accumulate device utilizing the non-volatile memory is used.

Also with an analog multiply-accumulate device utilizing a volatile memory, the present technology is effective, for example, in a case of performing calculations with a plurality of weight groups with respect to an identical input generated by one D/A converter or the like, in a case of performing sampling the outputs of the plurality of multiply-accumulate devices by using one A/D in a time division manner, or the like.

<Other Embodiments>

The present technology is not limited to the embodiment described above, and various other embodiments can be realized.

In the above description, in a case where the common signal output circuit 55 is arranged with respect to the plurality of arithmetic circuit units 5, the arrangement configuration PC and the common wiring unit WC according to the present technology are configured.

The present technology is not limited thereto, and the arrangement configuration PC and the common wiring unit WC according to the present technology can also be configured also in a case where the A/D converter or the like that receives the output (multiply-accumulate result signal) from each arithmetic circuit unit 5 is commonly arranged with respect to the plurality of arithmetic circuit units 5.

For example, the “plurality of multiply-accumulate result signal output lines” is defined with respect to each of the plurality of arithmetic circuit units 5.

The “plurality of multiply-accumulate result signal output lines” outputs the multiply-accumulate result signals representing multiply-accumulate results generated on the basis of the multiply-accumulate signals output from the plurality of output lines 51.

For example, in the arithmetic circuit unit 5 illustrated in FIGS. 9 and 10, the plurality of output signal lines 13 that outputs the multiply-accumulate result signals corresponds to the “plurality of multiply-accumulate result signal output lines”. In the arithmetic circuit unit 5 illustrated in FIGS. 11 and 12, each of the plurality of output signal lines 13 (positive output signal line 13a and negative output signal line 13b) corresponds to the “plurality of multiply-accumulate result signal output lines”.

That is, in the arithmetic apparatus 200 having the two-input two-output configuration, both of the positive output signal line 13a and the negative output signal line 13b are the “plurality of multiply-accumulate result signal output lines” irrespective of whether they are positive or negative.

With respect to the plurality of arithmetic circuit units 5, the “signal input circuit” including the plurality of signal input lines into which the multiply-accumulate result signals respectively output from the “plurality of multiply-accumulate result signal output lines” are respectively input is configured.

In such a case, by configuring the arrangement configuration PC and the common wiring unit WC according to the present technology as described above, it is possible to make the wire lengths from each arithmetic circuit unit 5 to the signal input circuit equal, and it is also possible to reduce the wire lengths. As a result, the operation accuracy can be improved in an analog circuit that performs a multiply-accumulate operation.

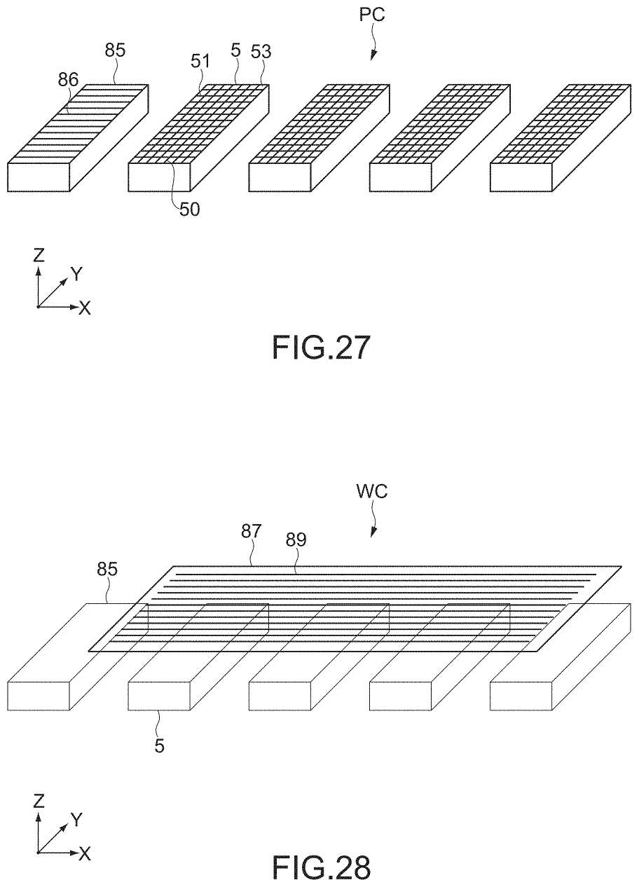

For example, as shown in FIG. 27, it is assumed that the four arithmetic circuit units 5 and the one signal input circuit 85 are arranged. The respective outputs of the four arithmetic circuit units 5 are input into a plurality of signal input lines 86 of the signal input circuit 85, switched as appropriate.

In such a case, the arrangement configuration PC as described above is configured.

Moreover, as shown in FIG. 28, a wiring reference plane 87 is set and a plurality of reference wires 89 is arranged so as to be parallel to the identical plane (horizontal plane) in which the four arithmetic circuit units 5 are arranged side by side.

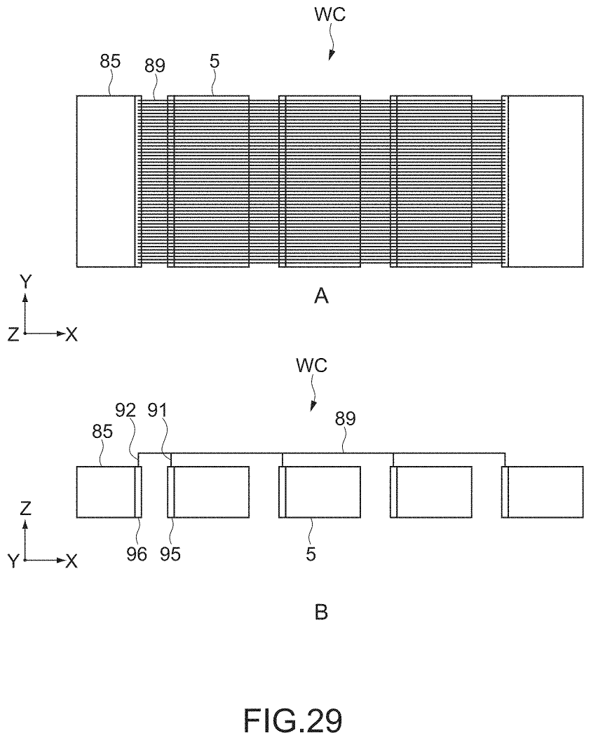

Moreover, as shown in FIG. 29, output-side wires 91 that electrically connect each arithmetic circuit unit 5 (output end portion 95) to the plurality of reference wires 89 and input-side wires 92 that electrically connect the plurality of reference wires 89 to the signal input lines 86 (input end portion 96) of the signal input circuit 85 are arranged.

In this manner, by constructing the common wiring unit WC, it is possible to make the wire lengths from each arithmetic circuit unit 5 to the signal input circuit 85 equal, and it is also possible to reduce the wire lengths. As a result, the arithmetic operation accuracy can be improved.

Moreover, in the configuration illustrated in FIG. 22, focus is put on the plurality of arithmetic circuit units 5 and the signal input circuit 85. The signal input circuit 85 includes the plurality of signal input lines 86.

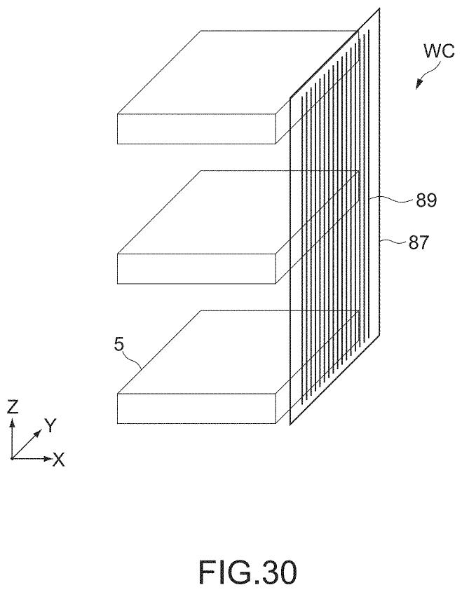

As shown in FIG. 30, the wiring reference plane 87 is set and the plurality of reference wires 89 is arranged in the vertical direction (Z direction) in which the three arithmetic circuit units 5 are arranged side by side.

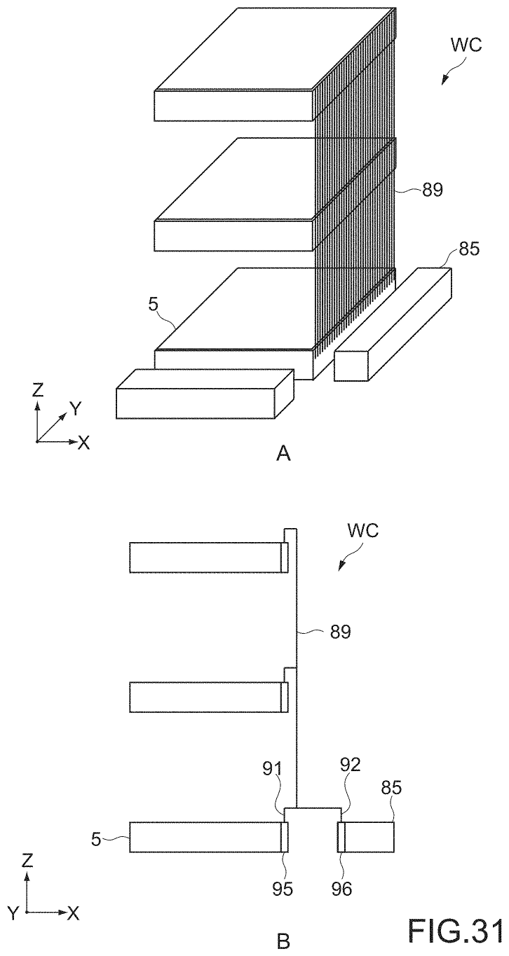

Moreover, as shown in FIG. 31, the output-side wires 91 that electrically connect each arithmetic circuit unit 5 (output end portion 95) to the plurality of reference wires 89 and the input-side wires 92 that electrically connect the plurality of reference wires 89 to the signal input lines 86 (input end portion 96) of the signal input circuit 85 are arranged.

In this manner, by constructing the common wiring unit WC, it is possible to make the wire lengths from each arithmetic circuit unit 5 to the signal input circuit 85 equal, and it is also possible to reduce the wire lengths. As a result, the arithmetic operation accuracy can be improved.

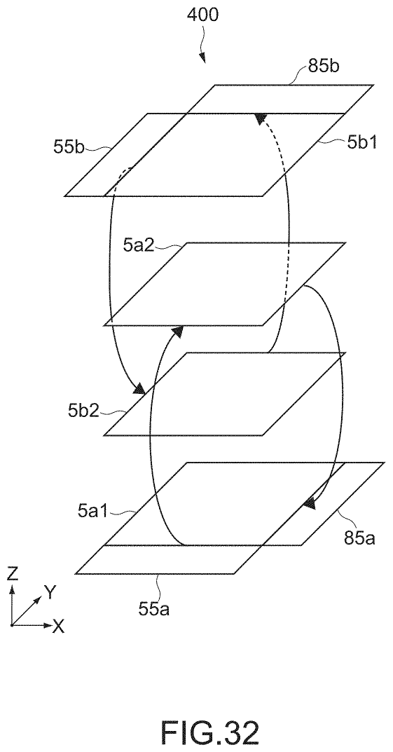

FIG. 32 is a schematic diagram showing another configuration example of the arithmetic apparatus.

In this arithmetic apparatus 400, a first arithmetic circuit unit 5a1 and a second arithmetic circuit unit 5a2 are arranged with respect to a signal output circuit 55a and a signal input circuit 85a. The arrangement configuration and the common wiring unit WC according to the present technology PC are constructed in a group including the signal output circuit 55a, the signal input circuit 85a, the first arithmetic circuit unit 5a1, and the second arithmetic circuit unit 5a2.

Moreover, a first arithmetic circuit unit 5b1 and a second arithmetic circuit unit 5b2 are arranged with respect to a signal output circuit 55b and a signal input circuit 85b. The arrangement configuration and the common wiring unit WC according to the present technology PC are constructed in a group including the signal output circuit 55b, the signal input circuit 85b, the first arithmetic circuit unit 5b1, and the second arithmetic circuit unit 5b2.

In this manner, the arithmetic apparatus according to the present technology may be configured to include a plurality of groups in each of which the arrangement configuration PC and the common wiring unit WC according to the present technology are constructed.

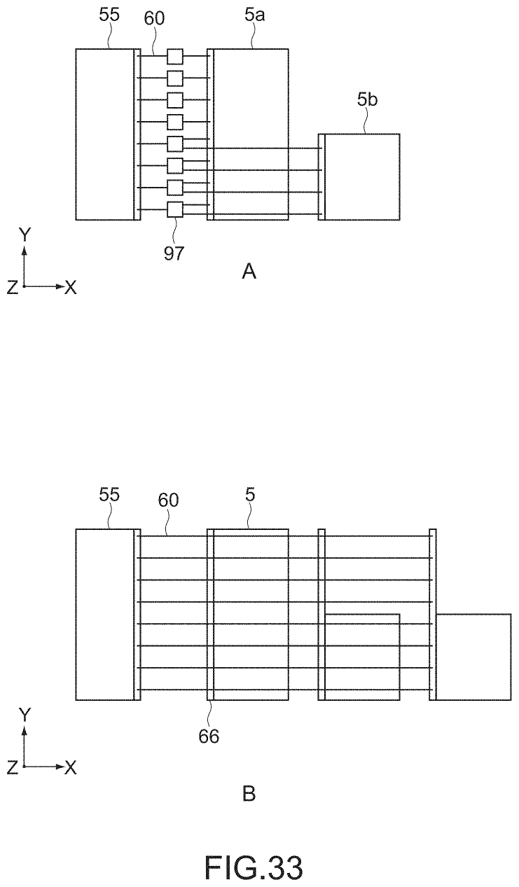

FIG. 33 is a schematic diagram for describing a case where the number of inputs of each of the plurality of arithmetic circuit units 5 (number of input signal lines 7) is different.

For example, as shown in FIG. 33A, a method of switching the wiring routes by using circuits or the like is conceivable.

For example, an MUX 97 is arranged in each signal line of the common wiring unit WC (e.g., each line of the plurality of reference wires 60). Then, by controlling the MUXs 97 as appropriate, the input into the first arithmetic circuit unit 5a and the input into the second arithmetic circuit unit 5b are switched as appropriate.

In a case of this method, primarily unnecessary wires can be eliminated, and an effect that the power efficiency and the like can be improved is exerted.

It should be noted that instead of the MUX 97, a buffer with enable or the like may be provided in each signal output line of the signal output circuit 55. Then, by controlling the buffers, a signal output line from which an electrical signal is output may be selectable as appropriate.

As shown in FIG. 33B, a method of commonly configuring all the routes to the input end portion 66 in the wires to each arithmetic circuit unit 5 is conceivable.

In a case of this method, primarily in the wire to each arithmetic circuit unit 5, effects that variations in delay time can be reduced and the circuit configuration for switching can be omitted are exerted.

It should be noted that the common wiring unit may be provided with a buffer with enable or the like for switching the input into each arithmetic circuit unit 5.

In the above description, the arithmetic apparatus according to the time-axis analog multiply-accumulate method in which information is transmitted using the timing (point of time) or the pulse width (period of time) has been exemplified. However, the present technology can also be applied to an arithmetic apparatus according to an analog multiply-accumulate method in which information is transmitted using voltage or current. In a case where the common signal output circuit 55 is used for the plurality of arithmetic circuit units 5 or in a case where the common signal input circuit 85 is used for the plurality of arithmetic circuit units 5, the arrangement configuration PC and the common wiring unit WC according to the present technology are constructed. Accordingly, it is possible to reduce irregularities in the delay time (wiring delay) of analog signals (current or voltage). Accordingly, a standby time until all input signals of the arithmetic circuit units become stable can be reduced and the latency can be shortened.

In the above description, the inference apparatus has been exemplified as the arithmetic apparatus including the plurality of arithmetic circuit units. The present technology is not limited thereto, and the present technology can also be applied to another arithmetic apparatus including a plurality of arithmetic circuit units.

In the above description, the case of outputting the multiply-accumulate result signal on the basis of the timing at which the voltage retained by the accumulation unit increases beyond the threshold value has been exemplified. However, a configuration to output the multiply-accumulate result signal on the basis of the timing at which the voltage retained by the accumulation unit decreases beyond the threshold voltage may be employed. For example, charging is performed in advance until the voltage of the capacitor that functions as the accumulation unit reaches a predetermined preset value. After the sum of charges each corresponding to the product value of the signal value and the weight value is accumulated, the capacitor is discharged at a predetermined rate. In such a case, the multiply-accumulate result signal can be output on the basis of a timing at which the voltage retained by the capacitor decreases below the threshold value. As a matter of course, the present technology is not limited to such a configuration. It should be noted that in the present disclosure, discharging the capacitor is included in charging the capacitor with negative charges.

In the above description, the case where the pair of output lines is used has been described. The present technology is not limited thereto, and three or more output lines may be provided. That is, the present technology described above can be applied also in a case where one or more any number of output lines are used. For example, the multiplication unit includes a resistor that is connected between an associated input line and any one of the one or more output lines and defines a weight value, and outputs a charge corresponding to the product value to the output line to which the resistor is connected. As a matter of course, the present technology is not limited thereto.

The configurations of the arithmetic apparatus, the multiply-accumulate devices, the analog circuits, the synapse circuits, the neuron circuits, the arrangement configuration, the common wiring unit, and the like, the method of generating the multiply-accumulate result signal, the method of switching the input into the arithmetic circuit unit, and the like described above with reference to the drawings are merely an embodiment, and can be arbitrarily modified without departing from the gist of the present technology. That is, any other configurations, methods, and the like for carrying out the present technology may be employed.

In the present disclosure, concepts defining the shape, the size, the positional relationship, the state, and the like, such as “center”, “middle”, “uniform”, “equal”, the “same”, “orthogonal”, “parallel”, “vertical”, “symmetric”, “extending”, “axial”, “rectangular parallelepiped shape”, “curved shape”, “curve line shape”, “curve line shape”, and “lens shape”, are concepts including “substantially center”, “substantially middle”, “substantially uniform”, “substantially equal”, “substantially the same”, “substantially orthogonal”, “substantially parallel”, “substantially vertical”, “substantially symmetric”, “substantially extending”, “substantially axial”, “substantially rectangular parallelepiped shape”, “substantially curved surface shape”, “substantially curve line shape”, “substantially curve line shape”, “substantially lens shape” and the like.

For example, predetermined ranges (e.g., a range of error and a predetermined range of ±10%) and the like with reference to “completely center”, “completely middle”, “completely uniform”, “completely equal”, “completely the same”, “completely orthogonal”, “completely parallel”, “completely vertical”, “completely symmetric”, “completely extending”, “completely axial”, “completely axial”, “completely rectangular parallelepiped shape”, “completely curved surface shape”, “completely curve line shape”, “completely curve line shape”, “completely lens shape” and the like are also included.

At least two of the features of the present technology described above may be combined. In other words, various features described in the respective embodiments may be arbitrarily combined across the embodiments. Moreover, the various effects described above are not limitative but are merely illustrative, and other effects may be provided.

It should be noted that the present technology can also take the following configurations.
(1) An arithmetic apparatus, including:

a plurality of arithmetic circuit units each including
a plurality of input lines which is arranged in parallel using a predetermined direction as an extending direction and into which electrical signals corresponding to input values are respectively input, and
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on the basis of the electrical signals input into the plurality of input lines, by weight values;

a signal output circuit including a plurality of signal output lines capable of outputting electrical signals, respectively; and

a common wiring unit that electrically connects the plurality of signal output lines of the signal output circuit to the plurality of input lines, which each of the plurality of arithmetic circuit units includes, in which

the plurality of arithmetic circuit units includes a first arithmetic circuit unit and a second arithmetic circuit unit,

the electrical signals output from the plurality of signal output lines of the signal output circuit are input into the plurality of input lines, which each of the first arithmetic circuit unit and the second arithmetic circuit unit includes, as electrical signals corresponding to the input values via the common wiring unit, and

the extending direction of the plurality of output lines of the first arithmetic circuit unit and the extending direction of the plurality of output lines of the second arithmetic circuit unit are configured to be parallel to each other.
(2) The arithmetic apparatus according to (1), in which

the common wiring unit is configured using, as a reference, a wiring reference plane set on the basis of a positional relationship between the first arithmetic circuit unit and the second arithmetic circuit unit.
(3) The arithmetic apparatus according to (2), in which

the common wiring unit includes a plurality of reference wires that is arranged in parallel and extends in an identical direction on the wiring reference plane.
(4) The arithmetic apparatus according to (2) or (3), in which

in each of the plurality of arithmetic circuit units, the plurality of input lines and the plurality of output lines are arranged by using a predetermined plane as a reference plane, and

the wiring reference plane is set on the basis of a positional relationship between a first reference plane that is the reference plane of the first arithmetic circuit unit and a second reference plane that is the reference plane of the second arithmetic circuit unit.
(5) The arithmetic apparatus according to (4), in which

the first reference plane and the second reference plane are disposed to be arranged side by side on an identical plane, and

the wiring reference plane is set to be parallel to the identical plane on which the first reference plane and the second reference plane are disposed.
(6) The arithmetic apparatus according to (5), in which

the common wiring unit includes a plurality of reference wires that is arranged in parallel and extends in an identical direction on the wiring reference plane, and

the extending direction of the plurality of reference wires is set to be parallel to a direction in which the first reference plane and the second reference plane are arranged side by side.
(7) The arithmetic apparatus according to (6), in which

the first reference plane and the second reference plane are arranged side by side in the extending direction of the plurality of input lines of the first arithmetic circuit unit or the extending direction of the plurality of output lines of the first arithmetic circuit unit.
(8) The arithmetic apparatus according to (4), in which

the first reference plane and the second reference plane are arranged side by side to be orthogonal to a predetermined reference direction, and

the wiring reference plane is set to be parallel to the reference direction.
(9) The arithmetic apparatus according to (8), in which

the wiring reference plane is set to be parallel to the reference direction and the extending direction of the plurality of output lines of the first arithmetic circuit unit.
(8) The arithmetic apparatus according to (9), in which

the common wiring unit includes a plurality of reference wires that is arranged in parallel and extends in an identical direction on the wiring reference plane, and

the extending direction of the plurality of reference wires is set to be parallel to be the reference direction.
(11) The arithmetic apparatus according to any one of (2) to (10), in which

the common wiring unit includes a plurality of reference wires that is arranged in parallel and extends in an identical direction on the wiring reference plane, and

the common wiring unit includes at least one of a first wiring unit that electrically connects the plurality of signal output lines of the signal output circuit to the plurality of reference wires, a second wiring unit that electrically connects the plurality of reference wires to the plurality of input lines of the first arithmetic circuit unit, or a third wiring unit that electrically connects the plurality of reference wires to the plurality of input lines of the second arithmetic circuit unit.
(12) The arithmetic apparatus according to (11), in which

the common wiring unit includes the first wiring unit, the second wiring unit, and the third wiring unit, and

the first wiring unit, the second wiring unit, and the third wiring unit extend in an identical direction.
(13) The arithmetic apparatus according to (11) or (12), in which

the common wiring unit includes the second wiring unit and the third wiring unit, and

the second wiring unit and the third wiring unit are constituted by an identical wiring unit.
(14) The arithmetic apparatus according to any one of (2) to (13), in which

the common wiring unit includes a plurality of reference wires that is arranged in parallel and extends in an identical direction on the wiring reference plane, and

the plurality of reference wires is connected to each of end portions on an output side of the plurality of signal output lines of the signal output circuit, end portions on an input side of the plurality of input lines of the first arithmetic circuit unit, and end portions on an input side of the plurality of input lines of the second arithmetic circuit unit.
(15) The arithmetic apparatus according to any one of (1) to (14), in which

the extending direction of the plurality of input lines of the first arithmetic circuit unit and the extending direction of the plurality of input lines of the second arithmetic circuit unit are configured to be parallel to each other.
(16) The arithmetic apparatus according to any one of (1) to (15), in which

the plurality of signal output lines of the signal output circuit is arranged in parallel and extends in an identical direction, and

the extending direction of the plurality of signal output lines of the signal output circuit is configured to be parallel to the extending direction of the plurality of input lines of the first arithmetic circuit unit.
(17) The arithmetic apparatus according to any one of (1) to (16), in which

the extending direction of the plurality of output lines, which each of the plurality of arithmetic circuit units includes, is configured to be parallel to the extending direction of the plurality of output lines of the first arithmetic circuit unit, and

the electrical signals output from the plurality of signal output lines of the signal output circuit are input into the plurality of input lines, which each of the plurality of arithmetic circuit units includes, as the electrical signals corresponding to the input value via the common wiring unit.
(18) The arithmetic apparatus according to any one of (1) to (17), in which

the common wiring unit includes a switch unit that outputs the electrical signals output from the plurality of signal output lines of the signal output circuit to each of the plurality of arithmetic circuit units in a switchable manner.
(19) An arithmetic apparatus, including:

a plurality of arithmetic circuit units each including
a plurality of input lines which is arranged in parallel using a predetermined direction as an extending direction and into which electrical signals corresponding to input values are respectively input,
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on the basis of the electrical signals input into the plurality of input lines, by weight values, and
a plurality of multiply-accumulate result signal output lines that outputs multiply-accumulate result signals representing multiply-accumulate results generated on the basis of the multiply-accumulate signals output through the plurality of output lines;

a signal input circuit including a plurality of signal input lines into each of which the multiply-accumulate result signal output from each of the plurality of multiply-accumulate result signal output lines is input; and

a common wiring unit that electrically connects the plurality of multiply-accumulate result signal output lines, which each of the plurality of arithmetic circuit units includes, to the plurality of signal input lines of the signal input circuit, in which

the plurality of arithmetic circuit units includes a first arithmetic circuit unit and a second arithmetic circuit unit,

the multiply-accumulate result signals output from the plurality of multiply-accumulate result signal output lines, which each of the first arithmetic circuit unit and the second arithmetic circuit unit includes, are input into the plurality of signal input lines of the signal input circuit, and

the extending direction of the plurality of output lines of the first arithmetic circuit unit and the extending direction of the plurality of output lines of the second arithmetic circuit unit are configured to be parallel to each other.
(20) A multiply-accumulate system, including:

a plurality of arithmetic circuit units each including
a plurality of input lines which is arranged in parallel using a predetermined direction as an extending direction and into which electrical signals corresponding to input values are respectively input, and
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on the basis of the electrical signals input into the plurality of input lines, by weight values;

a signal output circuit including a plurality of signal output lines capable of outputting electrical signals, respectively;

a common wiring unit that electrically connects the plurality of signal output lines of the signal output circuit to the plurality of input lines, which each of the plurality of arithmetic circuit units includes; and

a network circuit configured by connecting the plurality of arithmetic circuit units, in which

the plurality of arithmetic circuit units includes a first arithmetic circuit unit and a second arithmetic circuit unit,

the electrical signals output from the plurality of signal output lines of the signal output circuit are input into the plurality of input lines, which each of the first arithmetic circuit unit and the second arithmetic circuit unit includes as electrical signals corresponding to the input values via the common wiring unit, and

the extending direction of the plurality of output lines of the first arithmetic circuit unit and the extending direction of the plurality of output lines of the second arithmetic circuit unit are configured to be parallel to each other.

### REFERENCE SIGNS LIST

PC arrangement configuration
WC common wiring unit
1 signal line
3 analog circuit
5, 30 arithmetic circuit unit
7 input signal line
8 charge output line
9 synapse circuit
10 neuron circuit
13 output signal line 13
34 D/A converter
36 A/D converter
50 plurality of input lines
51 plurality of output lines
53 reference plane
55 signal output circuit
56 signal output line
57, 87 wiring reference plane
60, 89 reference wire
61 output-side wire
62 input-side wire
85 signal input circuit
86 signal input line
91 output-side wire
92 input-side wire
100, 200, 400 arithmetic apparatus
300 inference apparatus

1. An arithmetic apparatus, comprising:
a plurality of arithmetic circuit units each including
a plurality of input lines which is arranged in parallel using a predetermined direction as an extending direction and into which electrical signals corresponding to input values are respectively input, and
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on a basis of the electrical signals input into the plurality of input lines, by weight values;
a signal output circuit including a plurality of signal output lines capable of outputting electrical signals, respectively; and
a common wiring unit that electrically connects the plurality of signal output lines of the signal output circuit to the plurality of input lines, which each of the plurality of arithmetic circuit units includes, wherein
the plurality of arithmetic circuit units includes a first arithmetic circuit unit and a second arithmetic circuit unit,
the electrical signals output from the plurality of signal output lines of the signal output circuit are input into the plurality of input lines, which each of the first arithmetic circuit unit and the second arithmetic circuit unit includes, as electrical signals corresponding to the input values via the common wiring unit, and
the extending direction of the plurality of output lines of the first arithmetic circuit unit and the extending direction of the plurality of output lines of the second arithmetic circuit unit are configured to be parallel to each other.

2. The arithmetic apparatus according to claim 1, wherein
the common wiring unit is configured using, as a reference, a wiring reference plane set on a basis of a positional relationship between the first arithmetic circuit unit and the second arithmetic circuit unit.

3. The arithmetic apparatus according to claim 2, wherein
the common wiring unit includes a plurality of reference wires that is arranged in parallel and extends in an identical direction on the wiring reference plane.

4. The arithmetic apparatus according to claim 2, wherein
in each of the plurality of arithmetic circuit units, the plurality of input lines and the plurality of output lines are arranged by using a predetermined plane as a reference plane, and
the wiring reference plane is set on a basis of a positional relationship between a first reference plane that is the reference plane of the first arithmetic circuit unit and a second reference plane that is the reference plane of the second arithmetic circuit unit.

5. The arithmetic apparatus according to claim 4, wherein
the first reference plane and the second reference plane are disposed to be arranged side by side on an identical plane, and
the wiring reference plane is set to be parallel to the identical plane on which the first reference plane and the second reference plane are disposed.

6. The arithmetic apparatus according to claim 5, wherein
the common wiring unit includes a plurality of reference wires that is arranged in parallel and extends in an identical direction on the wiring reference plane, and
the extending direction of the plurality of reference wires is set to be parallel to a direction in which the first reference plane and the second reference plane are arranged side by side.

7. The arithmetic apparatus according to claim 6, wherein
the first reference plane and the second reference plane are arranged side by side in the extending direction of the plurality of input lines of the first arithmetic circuit unit or the extending direction of the plurality of output lines of the first arithmetic circuit unit.

8. The arithmetic apparatus according to claim 4, wherein
the first reference plane and the second reference plane are arranged side by side to be orthogonal to a predetermined reference direction, and
the wiring reference plane is set to be parallel to the reference direction.

9. The arithmetic apparatus according to claim 8, wherein
the wiring reference plane is set to be parallel to the reference direction and the extending direction of the plurality of output lines of the first arithmetic circuit unit.

10. The arithmetic apparatus according to claim 8, wherein
the common wiring unit includes a plurality of reference wires that is arranged in parallel and extends in an identical direction on the wiring reference plane, and
the extending direction of the plurality of reference wires is set to be parallel to be the reference direction.

11. The arithmetic apparatus according to claim 2, wherein
the common wiring unit includes a plurality of reference wires that is arranged in parallel and extends in an identical direction on the wiring reference plane, and
the common wiring unit includes at least one of a first wiring unit that electrically connects the plurality of signal output lines of the signal output circuit to the plurality of reference wires, a second wiring unit that electrically connects the plurality of reference wires to the plurality of input lines of the first arithmetic circuit unit, or a third wiring unit that electrically connects the plurality of reference wires to the plurality of input lines of the second arithmetic circuit unit.

12. The arithmetic apparatus according to claim 11, wherein
the common wiring unit includes the first wiring unit, the second wiring unit, and the third wiring unit, and
the first wiring unit, the second wiring unit, and the third wiring unit extend in an identical direction.

13. The arithmetic apparatus according to claim 1, wherein
the common wiring unit includes the second wiring unit and the third wiring unit, and
the second wiring unit and the third wiring unit are constituted by an identical wiring unit.

14. The arithmetic apparatus according to claim 2, wherein
the common wiring unit includes a plurality of reference wires that is arranged in parallel and extends in an identical direction on the wiring reference plane, and
the plurality of reference wires is connected to each of end portions on an output side of the plurality of signal output lines of the signal output circuit, end portions on an input side of the plurality of input lines of the first arithmetic circuit unit, and end portions on an input side of the plurality of input lines of the second arithmetic circuit unit.

15. The arithmetic apparatus according to claim 1, wherein
the extending direction of the plurality of input lines of the first arithmetic circuit unit and the extending direction of the plurality of input lines of the second arithmetic circuit unit are configured to be parallel to each other.

16. The arithmetic apparatus according to claim 1, wherein
the plurality of signal output lines of the signal output circuit is arranged in parallel and extends in an identical direction, and
the extending direction of the plurality of signal output lines of the signal output circuit is configured to be parallel to the extending direction of the plurality of input lines of the first arithmetic circuit unit.

17. The arithmetic apparatus according to claim 1, wherein
the extending direction of the plurality of output lines, which each of the plurality of arithmetic circuit units includes, is configured to be parallel to the extending direction of the plurality of output lines of the first arithmetic circuit unit, and
the electrical signals output from the plurality of signal output lines of the signal output circuit are input into the plurality of input lines, which each of the plurality of arithmetic circuit units includes, as the electrical signals corresponding to the input value via the common wiring unit.

18. The arithmetic apparatus according to claim 1, wherein
the common wiring unit includes a switch unit that outputs the electrical signals output from the plurality of signal output lines of the signal output circuit to each of the plurality of arithmetic circuit units in a switchable manner.

19. An arithmetic apparatus, comprising:
a plurality of arithmetic circuit units each including
a plurality of input lines which is arranged in parallel using a predetermined direction as an extending direction and into which electrical signals corresponding to input values are respectively input,
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on a basis of the electrical signals input into the plurality of input lines, by weight values, and
a plurality of multiply-accumulate result signal output lines that outputs multiply-accumulate result signals representing multiply-accumulate results generated on a basis of the multiply-accumulate signals output through the plurality of output lines;
a signal input circuit including a plurality of signal input lines into each of which the multiply-accumulate result signal output from each of the plurality of multiply-accumulate result signal output lines is input; and
a common wiring unit that electrically connects the plurality of multiply-accumulate result signal output lines, which each of the plurality of arithmetic circuit units includes, to the plurality of signal input lines of the signal input circuit, wherein
the plurality of arithmetic circuit units includes a first arithmetic circuit unit and a second arithmetic circuit unit,
the multiply-accumulate result signals output from the plurality of multiply-accumulate result signal output lines, which each of the first arithmetic circuit unit and the second arithmetic circuit unit includes, are input into the plurality of signal input lines of the signal input circuit, and
the extending direction of the plurality of output lines of the first arithmetic circuit unit and the extending direction of the plurality of output lines of the second arithmetic circuit unit are configured to be parallel to each other.

20. A multiply-accumulate system, comprising:
a plurality of arithmetic circuit units each including
a plurality of input lines which is arranged in parallel using a predetermined direction as an extending direction and into which electrical signals corresponding to input values are respectively input, and
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on a basis of the electrical signals input into the plurality of input lines, by weight values;
a signal output circuit including a plurality of signal output lines capable of outputting electrical signals, respectively;
a common wiring unit that electrically connects the plurality of signal output lines of the signal output circuit to the plurality of input lines, which each of the plurality of arithmetic circuit units includes; and
a network circuit configured by connecting the plurality of arithmetic circuit units, wherein
the plurality of arithmetic circuit units includes a first arithmetic circuit unit and a second arithmetic circuit unit,
the electrical signals output from the plurality of signal output lines of the signal output circuit are input into the plurality of input lines, which each of the first arithmetic circuit unit and the second arithmetic circuit unit includes as electrical signals corresponding to the input values via the common wiring unit, and
the extending direction of the plurality of output lines of the first arithmetic circuit unit and the extending direction of the plurality of output lines of the second arithmetic circuit unit are configured to be parallel to each other.
